(19) United States
(12) Patent Application Publication
(10) Pub. No.: US 2014/0074626 A1
(43) Pub. Date: Mar. 13, 2014

(54) INFORMATION PROCESSING APPARATUS AND METHOD, PROGRAM, AND INFORMATION PROCESSING SYSTEM

(71) Applicant: Sony Corporation, Tokyo (JP)

(72) Inventor: Takahiro Fukuhara, Kanagawa (JP)

(73) Assignee: Sony Corporation, Tokyo (JP)

(21) Appl. No.: 14/010,635

(22) Filed: Aug. 27, 2013

(30) Foreign Application Priority Data
Sep. 7, 2012 (JP) 2012-197116

(51) Int. Cl. G06Q 30/02

(52) U.S. Cl. CPC G06Q 30/0275
USPC 705/14.71

(57) ABSTRACT

The information processing apparatus includes: an extracting unit configured to extract predetermined feature information from an image; an order-information generating unit configured to generate order information for ordering competitive bidding for selecting output information, by using the feature information extracted by the extracting unit; a competitive-bidding unit configured to conduct the competitive bidding to select output information on the basis of the order information generated by the order-information generating unit; and an output unit configured to output the output information selected in the competitive bidding conducted by the competitive-bidding unit.

### BACKGROUND

The present technology generally relates to information processing apparatuses and methods, programs, and information processing systems. More particularly, the present technology relates to an information processing apparatus and method, a program, and an information processing system that are configured to be able to present more-appropriate information to users.

A typical advertising system in use today will be described below. For example, a most likely case is that, at the moment a user appears on the Internet, information about the user stored in a cookie in a browser he or she uses is extracted (e.g., a user ID, the number of times an advertisement banner was displayed, the date and time the advertisement banner was displayed the last time, the number of times the user has visited an advertiser's site, the date and time the user visited the site last time, estimated gender, estimated age, and other attributes).

Examples of the roles of cookies are:

To record and display how many times the visitor has visited a particular page.

To record the visitor's preferences in advance, such as an ordinary mode, a frame mode, and so on, and to display information in that mode at the next visit.

To record, in advance, a user name the user entered for a message board or chatting and to allow the user to skip entry of the user name at the next visit.

To establish a session through login.

With cookies, data such as that described above can be recorded on a hard disk at a client side (i.e., a browser-launching side) as data called “cookie information”.

A system that utilizes such cookies to provide an advertisement suitable (effective) for features of a user has been proposed (see, for example, Japanese Unexamined Patent Application Publication No. 2002-63452).

### SUMMARY

In such an advertising system, however, since the information of a cookie that a user left across the Internet in the past is used, there is a possibility that no effective advertisement is presented to a new user.

The present technology has been proposed in view of the foregoing situation, and it is desirable to present more-appropriate information to a user for whom no past history information is available.

According to one embodiment of the present technology, there is provided an information processing apparatus. The information processing apparatus includes: an extracting unit configured to extract predetermined feature information from an image; an order-information generating unit configured to generate order information for ordering competitive bidding for selecting output information, by using the feature information extracted by the extracting unit; a competitive-bidding unit configured to conduct the competitive bidding to select output information on the basis of the order information generated by the order-information generating unit; and an output unit configured to output the output information selected in the competitive bidding conducted by the competitive-bidding unit.

The feature information can include at least one of gender, age, body height, skin color, hairstyle, and clothing of a person included in the image.

The order-information generating unit can include the feature information and the order information including information regarding output information to be requested.

The competitive-bidding unit can select, from among pieces of output information submitted for the competitive bidding, output information having a bidding condition optimum for the order information.

The output information selected by the competitive-bidding unit has a bidding condition that matches a condition for requested output information and that is most appropriate for the feature information.

The information processing apparatus can further include an obtaining unit configured to obtain the image transmitted from another apparatus. The extracting unit can extract predetermined feature information from the image obtained by the obtaining unit.

The information processing apparatus can further include an image capture unit configured to capture an image of a subject. The extracting unit can extract predetermined feature information from the subject image captured by the image capture unit.

The output unit can display the output information as an image.

The output unit can supply the output information to another apparatus.

The information processing apparatus can further include a competitive-bidding result storage unit configured to store a result of the competitive bidding in conjunction with the feature information for the order information, the competitive bidding being conducted by the competitive-bidding unit.

The information processing apparatus can further include: an encoding unit configured to encode the image to obtain encoded data; and an encoded-data storage unit configured to store therein the encoded data obtained by the encoding unit.

The encoding unit can encode the image for each line block having a number of lines used for generating a lowest-frequency component for at least one line in a wavelet transform.

The information processing apparatus can further include a decoding unit configured to decode the encoded data generated by the encoding unit.

The information processing apparatus can further include: an obtaining unit configured to obtain encoded data supplied from another apparatus, the encoded data being data of the image subjected to encoding; and a decoding unit configured to decode the encoded data to obtain the image, the encoded data being obtained by the obtaining unit. The extracting unit can extract predetermined feature information from the image obtained by the decoding unit.

The encoded data may be data obtained by encoding the image for each line block having a number of lines used for generating a lowest-frequency component for at least one line in a wavelet transform, and the decoding unit can decode the encoded data for each line block.

The encoded data may data of the image subjected to the wavelet transform and entropy encoding. The decoding unit can include: an entropy decoding unit configured to perform entropy decoding on the encoded data to obtain wavelet-transformed coefficients; and an inverse wavelet transform unit configured to perform an inverse wavelet transform on the wavelet-transformed coefficients obtained by the entropy decoding unit.

The encoded data may be data of the image subjected to the wavelet transform, quantization, and entropy encoding. The decoding unit can further include a dequantizing unit configured to dequantize quantized wavelet-transformed coefficients to obtain wavelet-transformed coefficients, the quantized wavelet-transformed coefficients being obtained by the entropy decoding unit performing entropy decoding on the encoded data; and the inverse wavelet transform unit performs an inverse wavelet transform on the wavelet-transformed coefficients obtained by the dequantizing unit.

According to another embodiment of the present technology, there is provided an information processing method for an information processing apparatus. The method includes: extracting, by the information processing apparatus, predetermined feature information from an image; generating, by the information processing apparatus, order information for ordering competitive bidding for selecting output information, by using the extracted feature information; conducting, by the information processing apparatus, the competitive bidding to select output information on the basis of the generated order information; and outputting, by the information processing apparatus, the output information selected in the conducted competitive bidding.

According to still another embodiment of the present technology, there is provided a program for causing a computer to function as: an extracting unit that extracts predetermined feature information from an image; an order-information generating unit that generates order information for ordering competitive bidding for selecting output information, by using the feature information extracted by the extracting unit; a competitive-bidding unit that conducts the competitive bidding to select output information on the basis of the order information generated by the order-information generating unit; and an output unit that outputs the output information selected in the competitive bidding conducted by the competitive-bidding unit.

According to yet another embodiment of the present technology, there is provided an information processing system including: a terminal apparatus; and an information presenting apparatus. The terminal apparatus includes: an image capture unit configured to capture an image of a subject; an encoding unit configured to encode the subject image for each line block having a number of lines used for generating a lowest-frequency component for at least one line in a wavelet transform, to obtain encoded data, the subject image being captured by the image capture unit; a first supplying unit configured to supply the encoded data to the information presenting apparatus, the encoded data being obtained by the encoding unit; a first obtaining unit configured to obtain information from the information presenting apparatus; and an output unit configured to perform output on the basis of the information obtained by the first obtaining unit. The information presenting apparatus includes: a second obtaining unit configured to obtain the encoded data supplied by the first supplying unit in the terminal apparatus; a decoding unit configured to decode the encoded data for each line block to obtain the subject image, the encoded data being obtained by the second obtaining unit; an extracting unit configured to extract predetermined feature information from the subject image obtained by the decoding unit; an order-information generating unit configured to generate order information for ordering competitive bidding for selecting output information, by using the feature information extracted by the extracting unit; a competitive-bidding unit configured to conduct the competitive bidding to select the output information on the basis of the order information generated by the order-information generating unit; and a second supplying unit configured to supply information regarding the output information to the terminal apparatus, the output information being selected in the competitive bidding conducted by the competitive-bidding unit. The first obtaining unit in the terminal apparatus obtains the information supplied by the second supplying unit, and the output unit in the terminal apparatus outputs the output information on the basis of the obtained information.

According to one embodiment of the present technology, predetermined feature information is extracted from an image, order information for ordering competitive bidding for selecting output information is generated by using the extracted feature information, the competitive bidding is conducted to select output information on the basis of the generated order information, and the output information selected in the conducted competitive bidding is output.

According to one embodiment of the present technology, in the terminal apparatus in the information processing system including the terminal apparatus and the information presenting apparatus, an image of a subject is captured, the captured subject image for each line block having a number of lines used for generating a lowest-frequency component for at least one line in a wavelet transform is encoded to obtain encoded data, the encoded data is supplied to the information presenting apparatus, information is obtained from the information presenting apparatus, and output is performed on the basis of the obtained information. In the information presenting apparatus, the encoded data supplied by the terminal apparatus is obtained, the obtained encoded data for each line block is decoded to obtain the subject image, predetermined feature information is extracted from the obtained subject image, order information for ordering competitive bidding for selecting output information is generated by using the extracted feature information, the competitive bidding is conducted to select the output information on the basis of the generated order information, and information regarding the output information selected in the competitive bidding is supplied to the terminal apparatus. The terminal apparatus obtains the supplied information and outputs the output information on the basis of the obtained information.

According to the present technology, it is possible to provide information. In particular, it is possible to present more-appropriate information to users.

### BRIEF DESCRIPTION OF THE DRAWINGS

FIG. 1 is a block diagram illustrating a major configuration example of an advertisement presenting apparatus;

FIG. 2 illustrates an example of competitive bidding;

FIG. 3 is a flowchart illustrating an example of a flow of advertisement presenting processing;

FIG. 4 is a diagram illustrating a specific example of advertisement presentation;

FIG. 5 is a diagram illustrating a specific example of the advertisement presentation;

FIG. 6 is a block diagram illustrating a major configuration example of an advertisement presenting apparatus;

FIG. 7 is a flowchart illustrating an example of a flow of advertisement presenting processing;

FIG. 8 is a block diagram illustrating a major configuration of an advertisement presenting apparatus;

FIG. 9 is a flowchart illustrating an example of a flow of advertisement presenting processing;

FIG. 10 is a block diagram illustrating a major configuration of an advertisement presenting apparatus;

FIG. 11 illustrates an example of tiles;

FIG. 12 is a block diagram illustrating the configuration of one example of an image encoding unit;

FIG. 13 is schematic diagram schematically illustrating wavelet transform;

FIGS. 14A and 14B are schematic views schematically illustrating the wavelet transform;

FIG. 15 is a schematic diagram schematically illustrating wavelet transform when a lifting technique is applied to a 5×3 filter;

FIG. 16 is a schematic diagram schematically illustrating an inverse wavelet transform when the lifting technique is applied to a 5×3 filter;

FIG. 17 schematically illustrates an example in which the lifting-based filtering processing using the 5×3 filter is executed up to decomposition level 2;

FIGS. 18A to 18C schematically illustrate a flow of the wavelet transform and the inverse wavelet transform;

FIG. 19 is a flowchart illustrating an example of a flow of encoding processing;

FIG. 20 is a block diagram illustrating the configuration of one example of an image decoding unit;

FIG. 21 is a flowchart illustrating a flow of decoding processing;

FIG. 22 is a diagram schematically illustrating an example of parallel operations of processes performed in an advertisement presenting system;

FIG. 23 is a schematic diagram illustrating an example of transmission and reception of encoded data;

FIG. 24 is a flowchart illustrating an example of flow of advertisement presenting processing; and

FIG. 25 is a block diagram illustrating a major configuration example of a computer.

### DETAILED DESCRIPTION OF EMBODIMENTS

A description below will be given of modes (hereinafter referred to as “embodiments”) for implementing the present disclosure. The description will be given in the following order:

1. First Embodiment (Advertisement Presenting Apparatus)

2. Second Embodiment (Advertisement Presenting Apparatus)

3. Third Embodiment (Advertisement Presenting System)

4. Fourth Embodiment (Computer)

### 1. First Embodiment

### [Advertisement Presenting Apparatus]

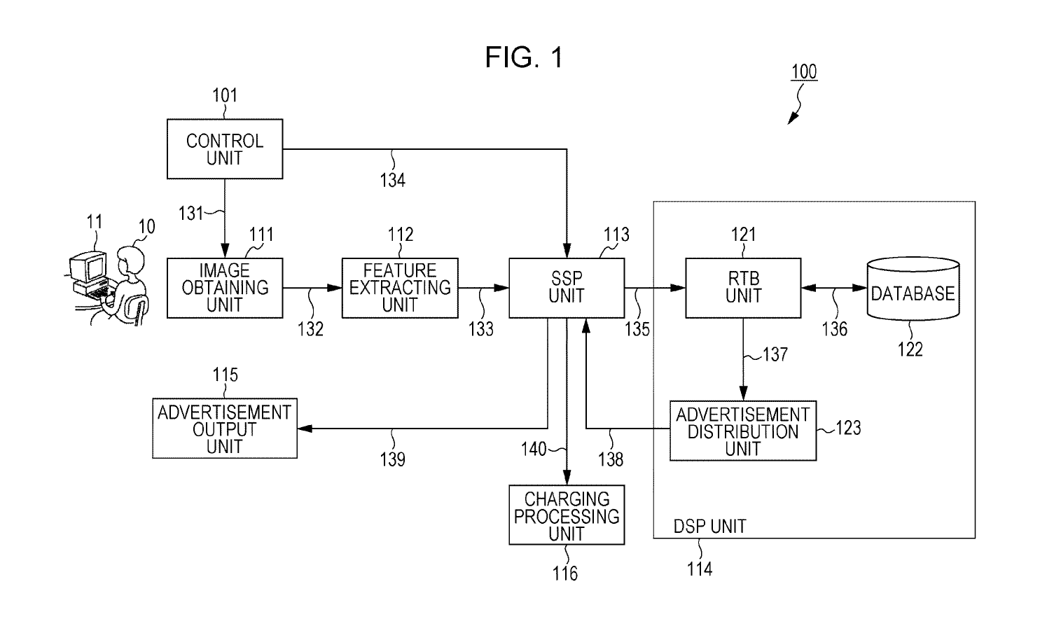

FIG. 1 is a block diagram illustrating a major configuration example of an advertisement presenting apparatus, which is one embodiment of an information processing apparatus to which the present technology is applied. An advertisement presenting apparatus 100 illustrated in FIG. 1 is one example of an information processing apparatus that presents appropriate output information to a user 10 via a terminal apparatus 11 of the user 10 or operated by the user 10.

The user 10 is a person who receives output information. The number of users 10 may be one or may be more than one (i.e., a group of users). The terminal apparatus 11 is, for example, equipment having at least an image-capture function for capturing an image of a subject and a communication function for communicating with another apparatus. Examples of the equipment include a stationary computer, such as a personal computer or audio-visual (AV) equipment, and a portable computer, such as a mobile phone, a smartphone, or a tablet-computer terminal.

The advertisement presenting apparatus 100 selects, for example, an advertisement in the form of an image, voice/sound, or the like, as output information and supplies the output information. Needless to say, the output information to be supplied may be arbitrary information and may be any information selected as appropriate information for the user 10. For example, the output information may be provided as guidance display of a movement route, a schedule, or the like or may be provided as a user interface customized for only the user 10. For example, the output information may be content of a movie, music, web site, or the like (or a combination thereof). For convenience of description, an advertisement including an image will hereinafter be described as the output information.

The advertisement presenting apparatus 100 selects advertisement information suitable for the user 10 on the basis of an image of the user 10 or the like. More specifically, the advertisement presenting apparatus 100 extracts, from an image of the user 10, predetermined feature information indicating features of the user 10 and selects an advertisement suitable for the user 10 on the basis of the feature information and so on.

The advertisement presenting apparatus 100 performs the advertisement selection through competitive bidding. Parties who wish to display their advertisements have pre-registered advertisement bids with the advertisement presenting apparatus 100. In each bid, information (advertisement information) regarding an advertisement image desired to be displayed and bidding conditions are set. The bidding conditions are arbitrary conditions. For example, the bidding conditions include features (a target condition) of a user who becomes a main target of the advertisement. For example, for the bidding conditions, multiple bidding conditions (target conditions) can also be set for one image. The bidding conditions may also include arbitrary information other than the target condition. The bidding conditions may include, for example, a bid price (advertising rate). For example, a bid price can also be set for each target condition. The bidding conditions may also include a condition, such as the time or a time slot when the advertisement can be displayed (or a recommended time or time slot). A case in which the bidding conditions include a target condition and a bid price are described below as one example.

The advertisement presenting apparatus 100 selects an optimum bid (in this case, a bid with the highest bid price) from a group of bids targeting the user 10 on the basis of the feature information of the user 10 and so on and supplies advertisement information corresponding to the selected bid.

With this arrangement, the advertisement presenting apparatus 100 can present more-appropriate information to a new user for whom no past history information is available.

As illustrated in FIG. 1, the advertisement presenting apparatus 100 includes a control unit 101, an image obtaining unit 111, a feature extracting unit 112, a supply-side platform (SSP) unit 113, a demand-side platform (DSP) unit 114, an advertisement output unit 115, and a charging processing unit 116.

The control unit 101 performs control processing related to advertisement presentation. For example, as indicated by arrow 131, the control unit 101 controls the image obtaining unit 111 to cause it to obtain an image of the user 10. As indicated by arrow 134, the control unit 101 also supplies information regarding specifications and so on of an advertisement to be requested (i.e., information regarding output information to be requested) to the SSP unit 113 to cause it to order competitive bidding for the advertisement. The information regarding the specifications and so on of the advertisement to be requested includes, for example, information regarding arbitrary conditions to be requested. Examples include a data type (such as an image or voice/sound), a data format, a data size, output time, a restriction on content of an inappropriate genre and so on, and various other conditions. The control unit 101 may itself generate information regarding the specifications and so on of the advertisement to be requested and supplies the generated information to the SSP unit 113. The control unit 101 may also obtain, from another apparatus that requests advertisement display (e.g., the terminal apparatus 11), information regarding the specifications and so on of the advertisement to be requested.

For example, under the control of the control unit 101, the image obtaining unit 111 obtains an image of the user 10 and supplies image data of the obtained image to the feature extracting unit 112, as indicated by arrow 132. The image obtaining unit 111 may have, for example, an image capture unit for capturing an image of a subject by an image sensor using a complementary metal-oxide semiconductor (CMOS) or a charge-coupled device (CCD). In such a case, the image obtaining unit 111 supplies image data of the image of the user 10, the image being acquired by the image capture, to the feature extracting unit 112. The image obtaining unit 111 may be, for example, a communication interface (or an input terminal) that communicates with another apparatus, such as the terminal apparatus 11, to obtain image data of the user 10, the image data being supplied from the other apparatus. In such a case, the image obtaining unit 111 supplies the image data of the image of the user 10, the image data being supplied from the other apparatus, to the feature extracting unit 112.

The feature extracting unit 112 performs digital image processing, which uses a predetermined image recognition technology and an analysis technology, on the image data (the image of the user 10) supplied from the image obtaining unit 111, to extract predetermined feature information indicating features of the subject (the user 10). However, the specifics (the image recognition technology and the analysis technology) of the digital image processing are not limiting. The contents of the feature information are also arbitrary. For example, the feature information may include the subject's gender, age, body height, skin color, hairstyle, or clothing features, or a combination thereof. Needless to say, the feature information may include features other than the aforementioned examples. The feature extracting unit 112 supplies the extracted feature information to the SSP unit 113, as indicated by arrow 133.

By using the feature information supplied from the feature extracting unit 112 and the information regarding the specifications and so on of the advertisement to be requested, the information being supplied from the control unit 101, the SSP unit 113 generates order information for ordering competitive bidding for selecting advertisement information. That is, for example, the order information includes the feature information and information regarding the specifications and so on of the advertisement to be requested. As indicated by arrow 135, the SSP unit 113 supplies the generated order information to the DSP unit 114 to order the competitive bidding for the advertisement to be requested.

The SSP is a tool that aids selling of advertisement spaces of mass media (or media), maximizing advertisement revenue, and so on in online advertising. More specifically, the SSP provides a mechanism that automatically selects an optimum advertisement each time an individual user appears on the Internet, to thereby improve profitability. Which specific scheme is to be used to select an advertisement is an item determined for each service. One example of the scheme is real-time bidding (RTB).

As indicated by arrow 138, the SSP unit 113 obtains a competitive-bidding result (e.g., the selected advertisement information, bidding information including information such as the bidding conditions and so on for the advertisement, and so on) supplied from the DSP unit 114 (specifically, an advertisement distribution unit 123 described below). As indicated by arrow 139, the SSP unit 113 supplies the advertisement information and the bidding information to the advertisement output unit 115.

In addition, when charging processing is to be performed on an advertisement distribution service using such competitive bidding, the SSP unit 113 supplies information, such as the competitive-bidding result, used for the charging processing to the charging processing unit 116, as indicated by arrow 140.

The DSP unit 114 conducts competitive bidding for the order from the SSP unit 113. The DSP unit 114 supplies, for example, information regarding the competitive bidding result to the SSP unit 113 that ordered the competitive bidding, as indicated by arrow 138. The information regarding the competitive bidding result includes information regarding the selected advertisement, bidding conditions, and so on. The DSP is a tool for aiding an advertiser side. More specifically, the DSP offers functions, such as optimum-advertisement-space selection based on user attributes and so on or distribution-condition optimization performed through reflection of past accomplishments.

As illustrated in FIG. 1, the DSP unit 114 has an RTB unit 121 and a database 122, in addition to the advertisement distribution unit 123.

The RTB unit 121 searches for, of bids pre-stored in the database 122, bids that satisfy various conditions contained in the order information supplied from the SSP unit 113. For example, as indicated by arrow 136, the RTB unit 121 searches for, of the bids pre-stored in the database 122, advertisement bids that match the specifications and so on of the requested advertisement and that target at the features of the user 10. The RTB unit 121 selects a most appropriate bid (i.e., a bid with favorable conditions) from a result of the search. The RTB unit 121 selects, for example, the bid with the highest bid price.

RTB is one mechanism for online advertising. In RTB, each time an advertising opportunity arises, competitive bidding for an advertisement space is conducted and an advertisement to be distributed is determined. In real-time bidding, one who wishes bidding pre-sets target user attributes, advertisement placement criteria, an advertisement space, a bid price, and so on. Then, when an advertising opportunity arises in one placement space, bids of buyers (advertisers) which meet conditions, such as an advertisement medium, a placement space, and user attributes, are sought and an advertisement of the highest bid buyer is distributed.

The time from when a bidding request is issued until an actual advertisement is eventually displayed is very short to a degree (e.g., 150 ms) that can be said to be real time. Thus, exchange of data between the SSP unit 113 and the DSP unit 114 and selection of a DSP party have been programmed on a computer and thus involve no manual labor.

As indicated by arrow 137, the RTB unit 121 supplies the advertisement information, which is information regarding the advertisement in the selected bid, and bidding information, which is information regarding the bidding result, the bidding conditions, and so on, to the advertisement distribution unit 123.

As indicated by arrow 138, the advertisement distribution unit 123 supplies the advertisement information, the bidding information, and so on, supplied from the RTB unit 121, to the SSP unit 113 as a competitive-bidding result.

The feature information of the user 10, the feature information being used for the competitive bidding, may also be stored in the database 122 in conjunction with information of the DSP party selected this time. Such an arrangement can realize a service in which, for example, when the same user appears next time, the selected DSP party is presented as an advertising candidate with higher priority.

The advertisement output unit 115 outputs the advertisement information supplied from the SSP unit 113. For example, the advertisement output unit 115 may have a monitor for displaying images so that an image including an advertisement image corresponding to the advertisement information supplied from the SSP unit 113 is displayed on the monitor. In addition, for example, the advertisement output unit 115 may have a speaker for outputting voice/sound so that voice/sound including advertisement voice/sound corresponding to the advertisement information supplied from the SSP unit 113 is output from the speaker.

Moreover, for example, the advertisement output unit 115 may have a communication interface (or an output terminal) for communicating with another apparatus. With such a configuration, the advertisement information supplied from the SSP unit 113 may be supplied to another apparatus via the communication interface (or the output terminal) so that an image including an advertisement image corresponding to the advertisement information is displayed on a monitor of the other apparatus or voice/sound including advertisement voice/sound corresponding to the advertisement information is output from a speaker of the other apparatus. The other apparatus may be the terminal apparatus 11 or an apparatus other than the terminal apparatus 11.

Needless to say, the advertisement output unit 115 may output an advertisement by a method other than the above-described method or may output an advertisement by multiple methods.

The charging processing unit 116 obtains information from the SSP unit 113, and performs charging processing regarding an advertisement distribution service using competitive bidding, on the basis of the obtained information. For example, when an operator of the advertisement presenting apparatus 100 is identical to an advertisement provider that presents an advertisement to the user 10, the charging processing unit 116 performs, on the DSP party whose bid was accepted, charging processing (such as collection of the bid price) corresponding to a bidding result. For example, when the operator of the advertisement presenting apparatus 100 is different from an advertisement provider that presents an advertisement to the user 10, the charging processing unit 116 performs charging processing, such as charging of a usage fee of the advertisement distribution service using the competitive bidding, on the advertisement provider that presents the advertisement to the user 10. In this case, the advertisement provider that presents the advertisement to the user 10 basically performs the charging processing (such as collection of the bid price) corresponding to the bidding result, the charging processing being performed on the DSP party whose bid was accepted. Needless to say, the charging processing unit 116 may perform the charging processing as a proxy.

### [Competitive Bidding]

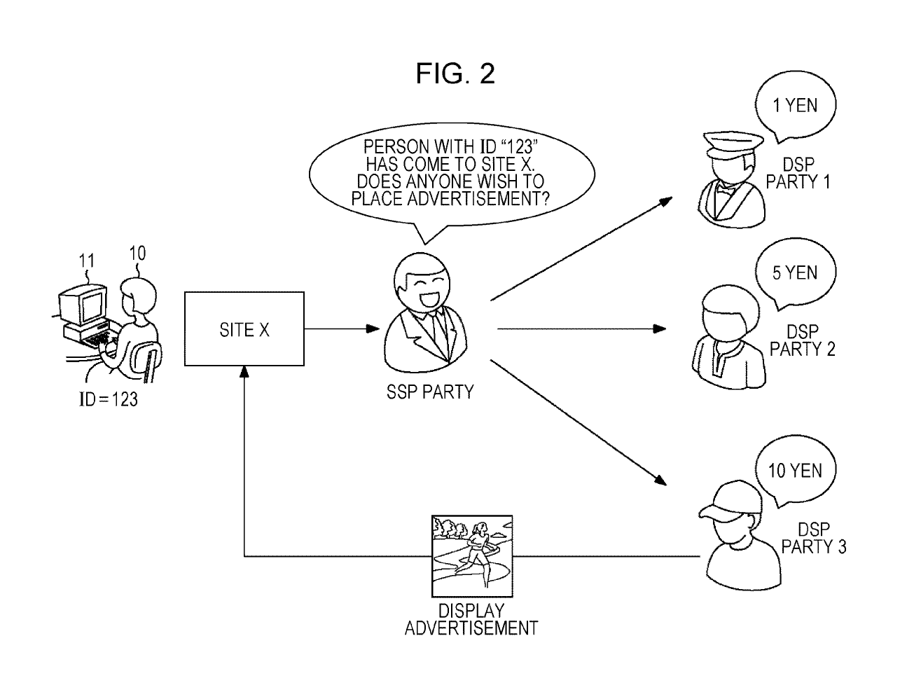

FIG. 2 specifically illustrates the relationship between the SSP and the DSPs. Operations in this case are performed according to the following flow.

1. The user 10 with ID “123” appears at site X on the Internet.

2. Personal information of the user 10 with ID “123” is transmitted from a browser at site X to an SSP party.

3. The SSP party selects DSP parties suitable for the user 10 (in the illustrated example, DSP parties 1 to 3) from pre-registered DSP parties (participants in the competitive bidding), by referring to the personal information of the user 10 with ID=123.

4. The SSP party presents an advertising auction (competitive bidding) to each of the DSP parties 1 to 3.

5. Of the DSP parties 1 to 3, the DSP party that presents the highest bid price (in the illustrated example, the DSP party 3) is selected.

6. A display advertisement (in practice, an HTML tag) of the selected DSP party 3 is transmitted to site X.

7. The user 10 with ID “123” sees the display advertisement, transmitted in operation 6, in his or her browser and clicks on the display advertisement if he or she likes it.

As one example of operation 3 described above, the SSP unit 113 supplies feature information including an image recognition result indicating that the user is female of around 20 years old to the RTB unit 121 in the DSP unit 114. On the basis of the feature information, the RTB unit 121 selects DSP parties that provide information about sites in which females in their twenties are likely to be interested. The RTB unit 121 then selects, from the DSP parties, a DSP party that has submitted the highest auction price.

One possible application example is that an advertising site for energy drinks, vitamin supplements, or the like which help people recover from fatigue is selected when severe fatigue of the user is recognized from his or her facial image. Another application example is that the intervals of opening and closing of the eyes are measured, it is determined that the user is falling asleep when it is recognized that his or her eyelids are closed for a certain period of time or more, and a video advertisement for waking him or her up, an advertisement for chewing gum or drinks for waking him or her up, or the like is displayed by referring to the feature information (indicating that he or she is falling asleep).

### [Flow of Advertisement Presenting Processing]

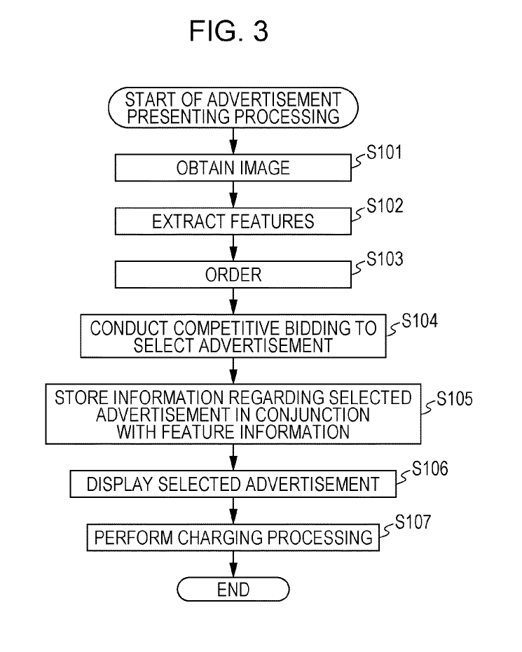

An example of a flow of the advertisement presenting processing performed by the advertisement presenting apparatus 100 illustrated in FIG. 1 will now be described with reference to a flowchart illustrated in FIG. 3.

The control unit 101 starts the advertisement presenting processing at a predetermined timing or in response to occurrence of a predetermined event.

Upon start of the advertisement presenting processing, in step S101, the image obtaining unit 111 obtains an image of the user 10 under the control of the control unit 101.

In step S102, the feature extracting unit 112 extracts, from the image obtained in step S101, features of the user 10 who is the subject thereof to obtain feature information.

In step S103, by using the feature information of the user 10, the feature information being obtained in the process in step S102, and the information regarding the specifications and so on of an advertisement to be requested, the information being obtained from the control unit 101, the SSP unit 113 generates order information for ordering competitive bidding for the advertisement to be requested. The SSP unit 113 uses the generated order information to order the competitive bidding.

In step S104, the RTB unit 121 in the DSP unit 114 conducts the competitive bidding to select a most appropriate advertisement for the user 10. The advertisement distribution unit 123 supplies the advertisement information and bidding information of the selected advertisement to the SSP unit 113 as a competitive-bidding result.

In step S105, the database 122 stores therein the information regarding the selected advertisement in conjunction with the corresponding feature information.

In step S106, the advertisement output unit 115 obtains the selected advertisement information from the SSP unit 113 and outputs the advertisement corresponding to the advertisement information. For example, the advertisement output unit 115 displays, on a monitor, an advertisement image corresponding to the advertisement information obtained from the SSP unit 113 (or an image including the advertisement image).

In step S107, the charging processing unit 116 performs charging processing on the basis of the information supplied from the SSP unit 113.

Upon completion of the process in step S107, the advertisement presenting processing ends.

By executing the advertisement presenting processing in the manner described above, the advertisement presenting apparatus 100 can select an advertisement on the basis of features of an image of a user. Thus, it is possible to present more-appropriate information to a new user for whom no past history information is available.

Next, a description will be given of a specific application example of the advertisement presenting apparatus 100.

### [Use Case 1]

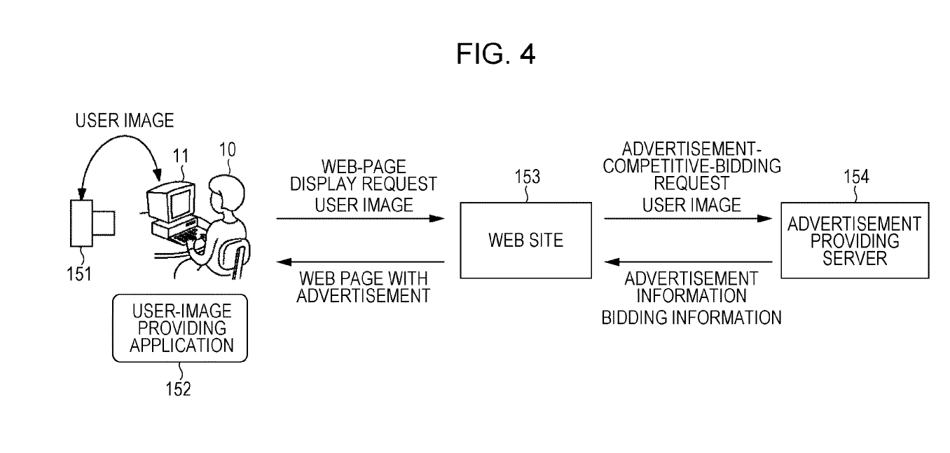

FIG. 4 is a diagram illustrating an example in which the advertisement presenting apparatus 100 is used for a web service. In a web service for providing a web page (as illustrated in FIG. 4), the advertisement presenting apparatus 100 illustrated in FIG. 1 can be used as an advertisement providing server 154.

For example, a terminal apparatus 11 operated by a user 10 is assumed to have an image capture device 151. In addition, a user-image providing application 152 supplied by a web site 153 is assumed to be pre-installed on the terminal apparatus 11.

Suppose that the user operates the terminal apparatus 11 to access the web site 153 through a browser (not illustrated) or the like. Upon accessing the web site 153, the user-image providing application 152 is launched by the browser or the like. The user-image providing application 152 then controls the image capture device 151 to capture an image of the user 10 and supplies the captured user image to a web server (not illustrated) of the web site 153 through a network (not illustrated), such as the Internet, in conjunction with a web-page display request.

The web site 153 dynamically generates the requested web page. While generating the web page, the web site 153 places an advertisement for the user 10 on the web page. In order to ensure that the advertisement to be placed on the web page is more appropriate (more useful) for the user 10, the web site 153 causes the advertisement providing server 154 to select the advertisement. That is, the web site 153 supplies an advertisement-competitive-bidding request, which requests competitive bidding for the advertisement, to the advertisement providing server 154 through the network (not illustrated), such as the Internet. The web site 153 also supplies the user image to the advertisement providing server 154 through the network (not illustrated), such as the Internet.

The advertisement-competitive-bidding request includes information regarding specifications and so on of the advertisement to be requested. Upon obtaining the advertisement-competitive-bidding request, the control unit 101 in the advertisement providing server 154 (the advertisement presenting apparatus 100) controls the image obtaining unit 111 to obtain the user image supplied from the web site 153.

The advertisement providing server 154 conducts competitive bidding based on features of the user image, as described above, to select a more appropriate (more useful) advertisement for the user 10. The advertisement providing server 154 supplies the advertisement information and the bidding information to the web site 153 through the network (not illustrated), such as the Internet, as a competitive-bidding result.

The web site 153 uses the supplied advertisement information to generate a web page accompanied by the advertisement and supplies the advertisement-accompanying web page to the terminal apparatus 11 through the network (not illustrated), such as the Internet. The terminal apparatus 11 displays an image of the advertisement-accompanying web page on the monitor.

When the user 10 accesses the web site 153, a desired web page with an advertisement suitable for the user 10 can be displayed on the terminal apparatus 11, as described above.

The terminal apparatus 11 may supply the user image to the web site 153 at any timing, for example, before the web-page display request is issued. However, the user image may be supplied simultaneously with or substantially simultaneously with the web-page display request issued when the user accesses the web site 153 for the first time. With this arrangement, the web site 153 can present more-appropriate information to a new user for whom no past history information is available.

The user-image providing application 152 may or may not be supplied from the web site 153. The destination to which the image is supplied by the user-image providing application 152 is not also limited to the web site 153. For example, the user-image providing application 152 may be supplied from the advertisement providing server 154, and the user-image providing application 152 may supply a user image to the advertisement providing server 154. In this case, for example, the user-image providing application 152 may be adapted to cause the image capture device 151 to capture an image of the user 10 under the control of the advertisement providing server 154. With this arrangement, for example, the advertisement providing server 154 can supply a service similar to the service for the web site 153 to multiple web sites operated by a party with which the advertisement providing server 154 has contracted.

### [Use Case 2]

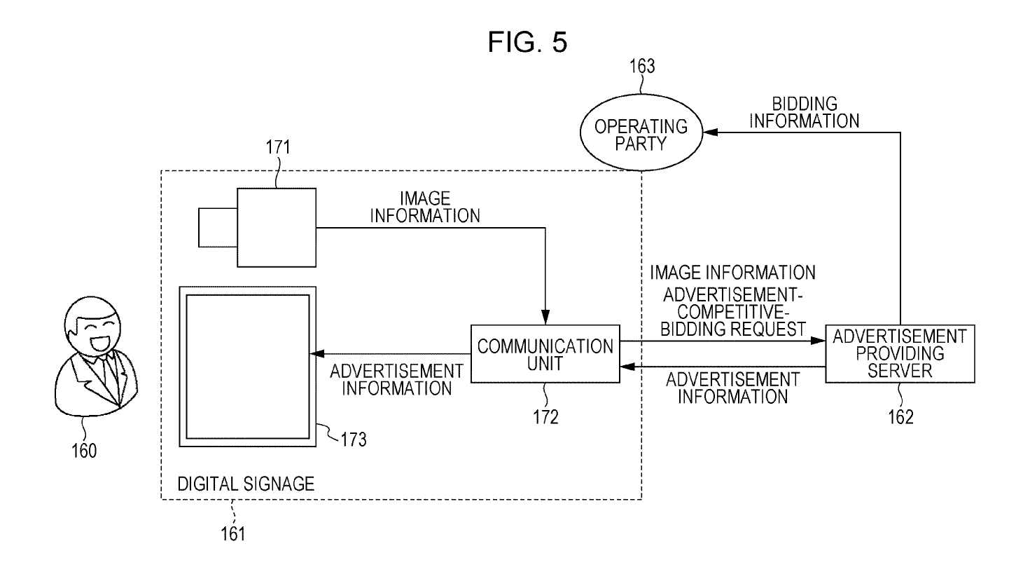

FIG. 5 is a block diagram illustrating an example in which the advertisement presenting apparatus 100 is used for an advertisement posting service using digital signage.

In recent years, public electronic signs called “digital signage” have been becoming more widespread. Digital signage is to transmit information typically by using electronic display devices, such as displays, at places other than ordinary homes, such as outdoors, in shops, and at transportation facilities.

Use of digital signage as advertisements for the public offers the following advantages:

It enables manipulation of display details through a network.

It enables updating of information to timely information in real time or stopping the distribution of information.

It involves no manual labor for printing, installation, and replacement.

It enables display of moving images.

It enables multiple clients (for advertising) to be sought for one installation place.

It attracts a great deal of attention.

In legacy advertisement displays, in general, content to be displayed is pre-determined and the content is displayed at predetermined time intervals. In contrast, when a passer-by 160 stops nearby a digital signage installation 161 illustrated in FIG. 5, the digital signage installation 161 dynamically generates an image including a more appropriate (more useful) advertisement for the passer-by 160 and displays the generated image on a monitor 173.

To this end, the digital signage installation 161 captures an image of the passer-by 160 by using an image capture device 171 placed in the vicinity of the monitor 173. Resulting image information of the passer-by 160 is supplied to a communication unit 172.

In order to ensure that an advertisement to be displayed is more appropriate (i.e., more useful) for the passer-by 160, the communication unit 172 causes an advertisement providing server 162 to select the advertisement. The advertisement presenting apparatus illustrated in FIG. 1 is used as the advertisement providing server 162. That is, the communication unit 172 supplies, to the advertisement providing server 162 through the network (not illustrated) such as the Internet, an advertisement-competitive-bidding request for requesting advertisement competitive bidding. The communication unit 172 also supplies image information of the passer-by 160, the image information being acquired by the image capture device 171, to the advertisement providing server 162 through the network (not illustrated), such as the Internet.

The advertisement-competitive-bidding request includes the aforementioned information regarding the specifications and so on of the advertisement to be requested. Upon receiving the advertisement-competitive-bidding request, the control unit 101 in the advertisement providing server 162 (the advertisement presenting apparatus 100) controls the image obtaining unit 111 to obtain the image information supplied from the digital signage installation 161.

The advertisement providing server 162 conducts the competitive bidding on the basis of features in the image information, as described above, and selects a more appropriate (more useful) advertisement for the passer-by 160. The advertisement providing server 162 supplies, as a competitive-bidding result, advertisement information to the communication unit 172 through the network (not illustrated), such as the Internet.

The communication unit 172 supplies the obtained advertisement information to the monitor 173, so that an image including the advertisement in the advertisement information is displayed on the monitor 173.

The present technology described above may be applied as described above, which makes it possible to realize a service in which an advertisement suitable for the passer-by 160 is displayed on the monitor 173 of the digital signage installation 161 when the passer-by 160 is in the vicinity of the digital signage installation 161.

The advertisement providing server 162 may be adapted to supply bidding information regarding the selected advertisement to an operating party 163 of the digital signage installation 161. The operating party 163 may perform collection of a fee for placing the advertisement and so on.

In the above-described service, since the advertisement providing server 162 selects the advertisement through real-time bidding, it is possible to present a more appropriate advertisement to a passer-by with lower delay. Thus, even when the passer-by 160 passes by the digital signage installation 161 without stopping in the vicinity of the digital signage installation 161 (e.g., passes in front of the monitor 173), a more suitable advertisement for the passer-by 160 can be displayed on the monitor 173 while he or she is passing.

Although a case in which one advertisement (or one DSP party) is selected through the competitive bidding has been described above, multiple advertisements (or DSP parties) may also be selected through the competitive bidding. For example, the advertisement providing server 162 may select, from advertisement candidates, multiple advertisements in a descending order of bid prices.

In such a case, for example, multiple small windows may be displayed within a single screen so that the advertisements are displayed in the respective different small windows. Such simultaneous display of multiple advertisements allows, for example, a user to touch and view one of the multiple advertisements that he or she desires.

The advertisement providing server 162 may also be adapted to be able to select an advertisement on the basis of information other than the features in the image information. For example, when the digital signage installation 161 is installed in a place where many people gather, such as a shop at a station, a DSP party that recognizes congestion and that presents a stress-relieving advertisement when the degree of congestion is high may be selected.

### 2. Second Embodiment

### [Advertisement Presenting Apparatus]

Images from which features are extracted may also be stored. The images may also be compressed for the storage.

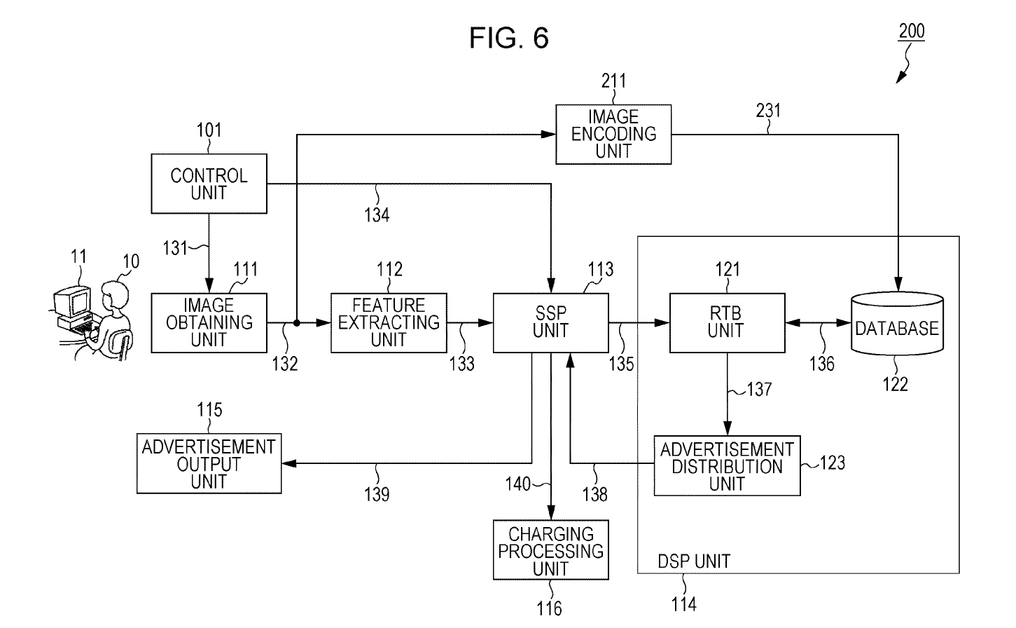

FIG. 6 is a block diagram illustrating a major configuration example of an advertisement presenting apparatus for the case in which the images are stored. An advertisement presenting apparatus 200 illustrated in FIG. 6 is basically the same as the advertisement presenting apparatus 100 illustrated in FIG. 1, has substantially the same configuration, and performs similar processing. The advertisement presenting apparatus 200, however, further has an image encoding unit 211.

In the case of the advertisement presenting apparatus 200, the image obtaining unit 111 further supplies the image data of the image of the user 10 to the image encoding unit 211, as indicated by arrow 132.

The image encoding unit 211 encodes the supplied image data to generate encoded data. The image encoding may be performed by any method that can reduce the data size. As indicated by arrow 231, the image encoding unit 211 supplies the encoded data, which was generated from the image data and has a smaller data size than the image data, to the database 122 for storage.

The database 122 stores therein the supplied encoded data in association with, for example, the feature information corresponding to the encoded data (image data), the information regarding the bidding result, and so on. The encoded data may be utilized, for example, during advertisement selection in conjunction with the feature information. For example, during search for an advertisement that matches a target, not only is the search performed based on the feature information, but also the search may be performed based on the degree of similarity of images and so on. Needless to say, the encoded data stored in the database 122 may be utilized for any other purposes.

Although the image encoding unit 211 may employ any method for the image encoding, as described above, it is desirable that the encoding be completed during the competitive bidding. With such an arrangement, for example, when the feature information and so on are stored in the database 122, the generated encoded data can also be stored in association therewith. Thus, it is desirable that the encoding be performed with lower delay.

In Moving Picture Experts Group (MPEG) 2 systems and H.264 systems (both of which are prominent in moving image compression), adjacent frames are used for prediction in order to improve the compression ratios. Consequently, the delay time increases (typically, to about 500 ms). Thus, the delay time does not fall within, for example, the range of up to 150 ms desired for real-time advertisement providing services.

Typically, a captured image is output line-by-line in sequence starting from the top line. When the time at which the top line in the image is input to an encoder is indicated by T1 and the time at which first encoded data are output from the encoder is indicated by T2, the delay time is given by T2−T1.

Systems that have been available for encoders for achieving low delay include, for example, a system for performing encoding for each picture and a system for performing encoding for each of multiple rectangular blocks resulting from subdivision of one picture to thereby further reduce the delay time. Examples of such systems are JPEG and JPEG 2000 systems.

The delay time for a real-time advertisement providing service as described above may be, for example, about 100 to 120 ms in the case of the typical Internet. Thus, it is desirable that the encoding scheme for the image encoding unit 211 be implemented by a lower-delay encoding scheme. For example, the encoding scheme may be implemented by a low-delay encoding method as described below in a third embodiment.

Not only a first single picture of an image of a user is encoded, but also a moving image following the first picture may be sequentially encoded as multiple pictures. In the latter case, each picture may be stored in the database 122 in association with the corresponding feature information and so on in the same manner described above.

### [Flow of Advertisement Presenting Processing]

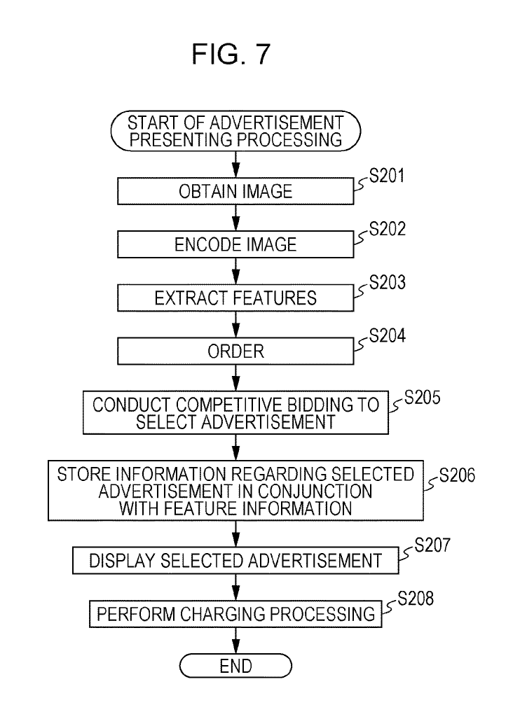

Next, an example of a flow of the advertisement presenting processing performed by the advertisement presenting apparatus 200 illustrated in FIG. 6 will be described with reference to a flowchart illustrated in FIG. 7.

The control unit 101 starts the advertisement presenting processing at a predetermined timing or in response to occurrence of a predetermined event.

Upon start of the advertisement presenting processing, in step S201, the image obtaining unit 111 obtains an image of the user 10 under the control of the control unit 101.

In step S202, the image encoding unit 211 encodes image data of the image obtained in step S201.

Processes in steps S203 to S205 are executed as in the processes in steps S102 to S104 illustrated in FIG. 3.

In step S206, the database 122 stores the information regarding the selected advertisement in conjunction with the corresponding feature information and the encoded data generated in step S202.

Processes in steps S207 and S208 are executed as in the processes in steps S106 and S107 illustrated in FIG. 3.

Upon completion of the process in step S208, the advertisement presenting processing ends.

By executing the advertisement presenting processing in the manner described above, the advertisement presenting apparatus 200 can present more-appropriate information to a new user for whom no past history information is available and can store the image data while suppressing an increase in the data size.

### [Advertisement Presenting Apparatus]

In addition, the arrangement may be such that the encoded data can be decoded.

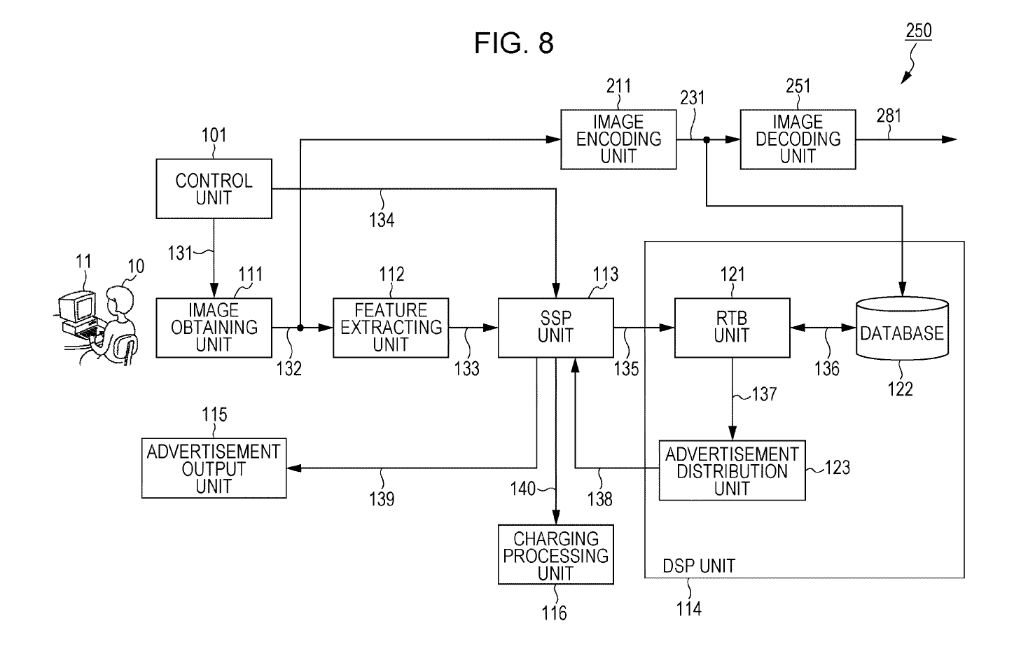

FIG. 8 is a block diagram illustrating a major configuration of an advertisement presenting apparatus that can decode the encoded data. An advertisement presenting apparatus 250 illustrated in FIG. 8 is basically the same as the advertisement presenting apparatus 200 illustrated in FIG. 6, has substantially the same configuration, and performs similar processing. The advertisement presenting apparatus 250, however, further has an image decoding unit 251.

In the case of the advertisement presenting apparatus 250, the image encoding unit 211 further supplies the encoded data to the image decoding unit 251, as indicated by arrow 231.

The image decoding unit 251 decodes the supplied encoded data by using a decoding method corresponding to the encoding scheme of the image encoding unit 211, to generate reconstructed image data. The image decoding unit 251 outputs the reconstructed image data to outside, as indicated by arrow 281. The output image data is supplied to, for example, an external monitor (not illustrated) or the like, on which the image is displayed.

It is desirable that the image decoding unit 251 decode the encoded data with low delay, as in the case of the image encoding unit 211. For a decoder, when the time at which first encoded data is received is indicated by T3 and the time at which output of a first image unit is started is indicated by T4, the delay time of the decoder is given by T4−T3.

### [Flow of Advertisement Presenting Processing]

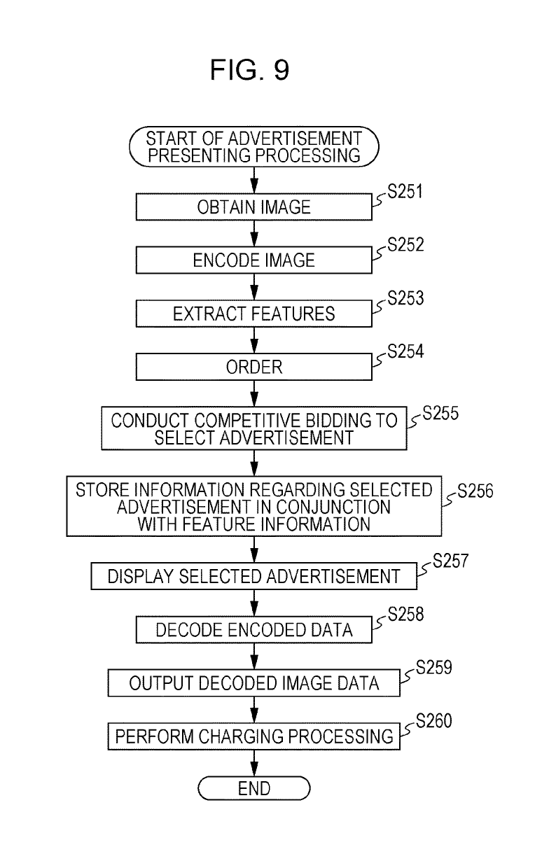

Next, an example of a flow of the advertisement presenting processing performed by the advertisement presenting apparatus 250 illustrated in FIG. 8 will be described with reference to a flowchart illustrated in FIG. 9.

The control unit 101 starts the advertisement presenting processing at a predetermined timing or in response to occurrence of a predetermined event.

Upon start of the advertisement presenting processing, processes in steps S251 to S257 are executed as in the processes in steps S201 to S207 illustrated in FIG. 7.

In step S258, the image decoding unit 251 decodes the encoded data, obtained in the process in step S252, to obtain decoded image data.

In step S259, the image decoding unit 251 outputs the decoded image data, obtained in the process in step S258, to outside.

A process in step S260 is executed as in the process in step S208 illustrated in FIG. 7.

Upon completion of the process in step S260, the advertisement presenting processing ends.

By executing the advertisement presenting processing in the manner described above, the advertisement presenting apparatus 250 can supply more-appropriate information to a new user for whom no past history information is available. Moreover, the advertisement presenting apparatus 250 can store the image data while suppressing an increase in the data size. In addition, the advertisement presenting apparatus 250 can output a decoded image.

### 3. Third Embodiment

### [Advertisement Presenting System]

Although the above description has been given of a case in which the advertisement presenting apparatus captures an image of the user 10 by itself to acquire the image data of the user 10 or a case in which the image data of the user 10 which is acquired at the terminal apparatus 11 is transmitted to the advertisement presenting apparatus without compression of the image data (i.e., is transmitted as raw data), a method for acquiring the image data is not limited thereto.

For example, the arrangement may be such that the image data of the user 10 which is acquired at the terminal apparatus 11 is compressed and the compressed data is transmitted to the advertisement presenting apparatus as encoded data.

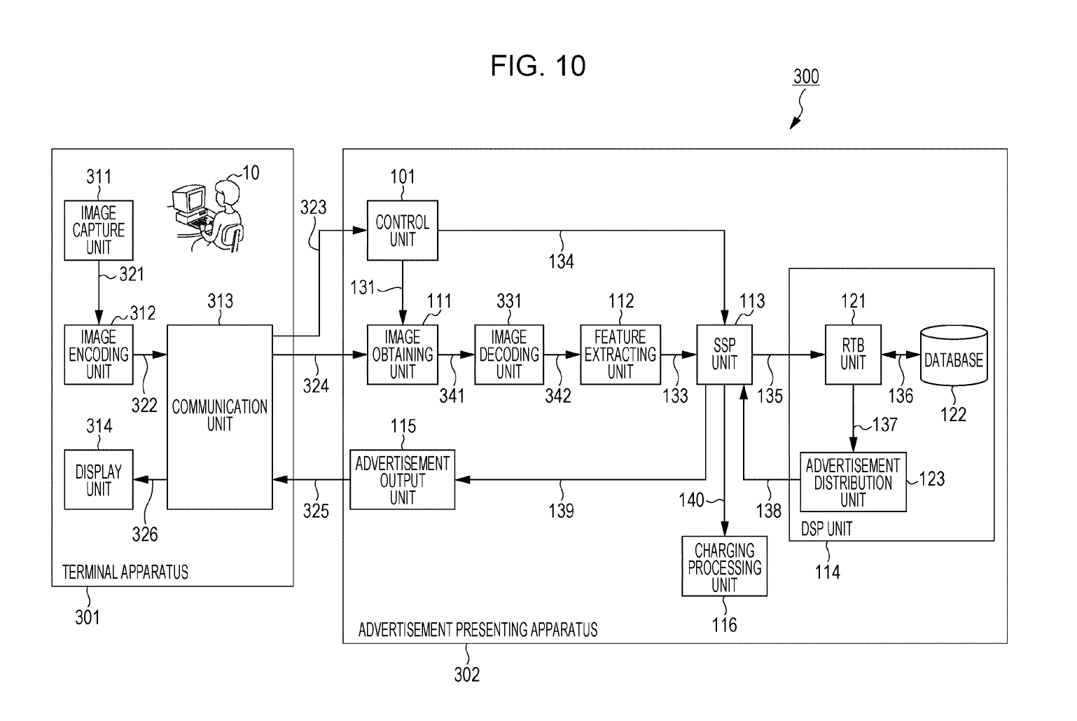

FIG. 10 is a block diagram illustrating a major configuration example of an advertisement presenting system for such an arrangement. An advertisement presenting system 300 illustrated in FIG. 10 includes a terminal apparatus 301 and an advertisement presenting apparatus 302. An advertisement is supplied from the advertisement presenting apparatus 302 to the terminal apparatus 301.

The terminal apparatus 301 is basically the same as or similar to the terminal apparatus 11 and is operated by a user 10. The advertisement presenting apparatus 302 is basically the same as or similar to the advertisement presenting apparatus 100 and so on described above, and supplies a more suitable (more useful) advertisement for the user 10 to the terminal apparatus 301 (the user 10), on the basis of a request from the terminal apparatus 301.

That is, the advertisement presenting system 300 is basically the same as the advertisement presenting apparatus 100 illustrated in FIG. 1 and the system using the terminal apparatus 11. In the case of the advertisement presenting system 300, however, the terminal apparatus 301 encodes the image data of the user 10 and supplies the resulting encoded data to the advertisement presenting apparatus 302. The advertisement presenting apparatus 302 decodes the supplied encoded data and uses the decoded data.

With this arrangement, it is possible to reduce a bandwidth used for the image-data transmission.

As illustrated in FIG. 10, the terminal apparatus 301 has an image capture unit 311, an image encoding unit 312, a communication unit 313, and a display unit 314.

The image capture unit 311 has an image sensor using a CMOS or CCD and captures, for example, an image of the user 10 who operates the terminal apparatus 301. The image capture unit 311 supplies image data resulting from the image capture to the image encoding unit 312, as indicated by arrow 321.

The image encoding unit 312 encodes the supplied image data to generate encoded data. The image encoding may be performed by any method that can reduce the data size. As indicated by arrow 322, the image encoding unit 312 supplies the encoded data, which was generated from the image data and has a smaller data size than the image data, to the communication unit 313 for storage.

The communication unit 313 serves as a communication interface using a predetermined communication system and communicates with, for example, the control unit 101, the image obtaining unit 111, and the advertisement output unit 115 in the advertisement presenting apparatus 302 through a network, such as the Internet.

For example, in order to ensure that an advertisement to be displayed is more appropriate (more useful) for the user 10, the communication unit 313 supplies an advertisement-competitive-bidding request for requesting advertisement competitive bidding to the control unit 101 in the advertisement presenting apparatus 302 through the network (not illustrated), such as the Internet, as indicated by arrow 323, so that the advertisement providing server 162 selects the advertisement.

For example, the communication unit 313 also supplies the encoded data, supplied from the image encoding unit 312, to the image obtaining unit 111 in the advertisement presenting apparatus 302 through the network (not illustrated), such as the Internet, as indicated by arrow 324, so that the encoded data can be used for the advertisement competitive bidding.

For example, as indicated by arrow 325, the communication unit 313 obtains a competitive-bidding result including the advertisement information, the competitive-bidding result being supplied from the advertisement output unit 115 in the advertisement presenting apparatus 302 through the network (not illustrated), such as the Internet, as a response to a request as described above. As indicated by arrow 326, the communication unit 313 supplies the obtained advertisement information and so on to the display unit 314.

The display unit 314 displays an image including the advertisement in the supplied advertisement information (i.e., presents the image to the user 10).

In turn, the advertisement presenting apparatus 302 basically has substantially the same configuration as the advertisement presenting apparatus 100 illustrated in FIG. 1 and performs similar processing. The advertisement presenting apparatus 302, however, further has an image decoding unit 331.

When the advertisement-competitive-bidding request for requesting advertisement competitive bidding is received from the communication unit 313 in the terminal apparatus 301, the control unit 101 controls the image obtaining unit 111, as indicated by arrow 131, to obtain an image on the basis of the advertisement-competitive-bidding request. As indicated by arrow 134, the control unit 101 also supplies information regarding requested advertisement specifications and so on contained in the advertisement-competitive-bidding request (i.e., information regarding requested output information) to the SSP unit 113 to order the advertisement competitive bidding.

Under the control of the control unit 101, the image obtaining unit 111 obtains the encoded data (resulting from encoding of the image data of the user 10) supplied from the communication unit 313 in the terminal apparatus 301 and supplies the encoded data to the image decoding unit 331, as indicated by arrow 341.

The image decoding unit 331 decodes the supplied encoded data by using a decoding scheme corresponding to the encoding scheme thereof (i.e., an encoding scheme for the encoding performed by the image encoding unit 312), to thereby obtain decoded image data. As indicated by arrow 342, the image decoding unit 331 supplies the obtained decoded image data to the feature extracting unit 112.

Each of the feature extracting unit 112, the SSP unit 113, the DSP unit 114, and the charging processing unit 116 executes corresponding processing, as in the case of the advertisement presenting apparatus 100 (FIG. 1).

As indicated by arrow 325, the advertisement output unit 115 supplies the advertisement information, supplied from the SSP unit 113, to the communication unit 313 in the terminal apparatus 301 through the network (not illustrated), such as the Internet.

As described above, the terminal apparatus 301 uses the encoded data, obtained by encoding the image data of the user 10, to request the advertisement presenting apparatus 302 to supply an advertisement to be presented to the user 10. In response to the request, the advertisement presenting apparatus 302 selects an appropriate advertisement on the basis of features of an image of the user 10 or the like, conducts competitive bidding in real time, selects an advertisement having an advantageous condition, and supplies the selected advertisement. The terminal apparatus 301 presents the advertisement, supplied from the advertisement presenting apparatus 302, to the user. With this arrangement, the advertisement presenting system can present appropriate information to the user.

In order to realize an advertisement providing service as described above with low delay, it is desirable that transmission of the image data (encoded data) between the terminal apparatus 301 and the advertisement presenting apparatus 302 be performed with lower delay. That is, it is desirable that the encoding performed by the image encoding unit 312 and the decoding performed by the image decoding unit 331 be performed with lower delay.

Systems that have been proposed for encoders for achieving low delay include, for example, a system for performing encoding for each picture and a system for performing encoding for each of multiple rectangular blocks resulting from subdivision of one picture to thereby further reduce the delay time. Examples of such systems are JPEG and JPEG 2000 systems. One typical example is a method for performing encoding for each of multiple tiles (rectangular blocks) resulting from division of a screen.

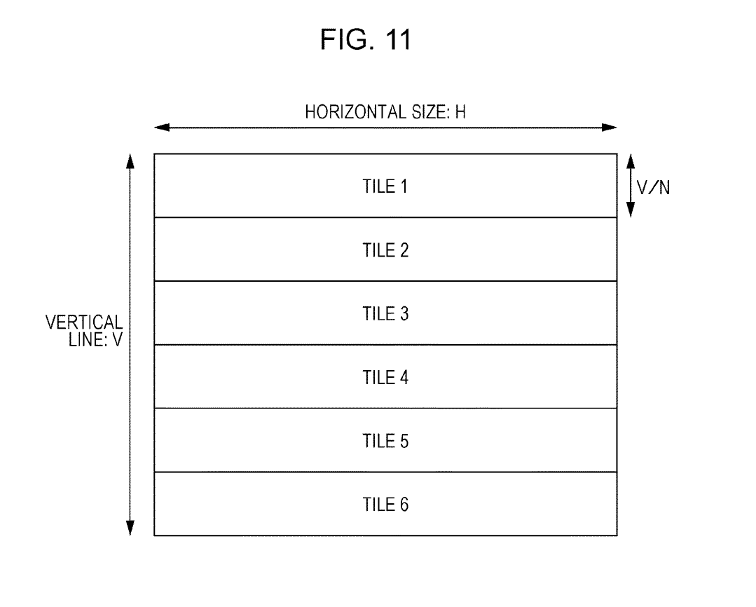

FIG. 11 illustrates typical tile encoding. In this example, one image is divided into six tiles. The size of the image to be encoded is H×(V/6). The image encoding unit 312 is adapted to encode the image (each tile) in accordance with an international standard, such as the JPEG or JPEG 2000 standard. In this case, the image decoding unit 331 also performs decoding for each tile. In this case, the delay time can be reduced by an amount corresponding to the tile division. In this system, since the tile size is reduced as the value of N is increased, there is an advantage in that the delay time is further reduced.

Other examples of low-delay encoding-and-decoding methods are disclosed in Japanese Patent No. 4900720 and Japanese Patent No. 4888729. With these disclosed encoding methods, first encoded data (i.e., a first bit stream) can be output with a delay time corresponding to some tens of lines in an image. Hence, for input of a moving image called a “full high-definition television (HDTV) image” (1920×1080@60I; 1920 horizontal pixels by 1080 vertical lines, 60 fields/s), the actual delay time is 10 ms or less. The aforementioned number of lines depends on the number of taps in a filter for a wavelet transform. For a 9×7 filter used for irreversible encoding in JPEG 2000, the delay time is long, and for a 5×3 filter for used reversible encoding, the delay time is short.

### [Low-Delay Encoding and Decoding]

The low-delay encoding-and-decoding scheme will now be described in more detail.

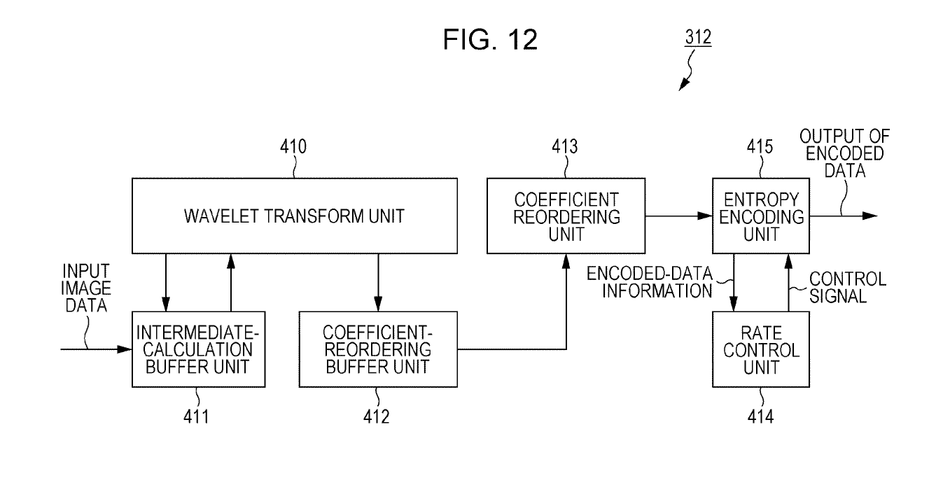

FIG. 12 is a block diagram illustrating the configuration of one example of the image encoding unit that performs low-delay encoding. In this case, as illustrated in FIG. 12, the image encoding unit 312 includes a wavelet transform unit 410, an intermediate-calculation buffer unit 411, a coefficient-reordering buffer unit 412, a coefficient reordering unit 413, a rate control unit 414, and an entropy encoding unit 415.

Image data (“input image data”) supplied from the image obtaining unit 111 is temporarily accumulated in the intermediate-calculation buffer unit 411. The wavelet transform unit 410 performs a wavelet transform on the image data accumulated in the intermediate-calculation buffer unit 411. That is, the wavelet transform unit 410 reads the image data from the intermediate-calculation buffer unit 411, performs filtering processing involving analysis filters on the read image data to generate low-frequency-component and high-frequency-component coefficient data, and stores the generated coefficient data in the intermediate-calculation buffer unit 411. The wavelet transform unit 410 has a horizontal analysis filter and a vertical analysis filter and performs analysis filtering processing on a group of image data in both a screen horizontal direction and a screen vertical direction. The wavelet transform unit 410 re-reads the low-frequency-component coefficient data stored in the intermediate-calculation buffer unit 411 and performs filtering processing involving the analysis filters on the read coefficient data to further generate high-frequency-component and low-frequency-component coefficient data. The generated coefficient data are stored in the intermediate-calculation buffer unit 411.

The wavelet transform unit 410 repeats the above-described processing, and when the decomposition level reaches a predetermined level, the wavelet transform unit 410 reads the coefficient data from the intermediate-calculation buffer unit 411 and writes the read coefficient data to the coefficient-reordering buffer unit 412.

The coefficient reordering unit 413 reads the coefficient data, written to the coefficient-reordering buffer unit 412, in a predetermined order, and supplies the read coefficient data to the entropy encoding unit 415. The entropy encoding unit 415 encodes the supplied coefficient data by using, for example, a predetermined entropy encoding scheme, such as Huffman coding or arithmetic coding.

The entropy encoding unit 415 operates in coordination with the rate control unit 414 and is controlled so that the bit rate of compressed encoded data to be output has a substantially constant value. That is, on the basis of encoded-data information from the entropy encoding unit 415, the rate control unit 414 outputs, to the entropy encoding unit 415, a control signal for performing control so that the encoding processing performed by the entropy encoding unit 415 is completed immediately before or at a point when the bit rate of data compressed and encoded by the entropy encoding unit 415 reaches a target value. The entropy encoding unit 415 outputs the encoded data when the encoding processing is completed in response to the control signal supplied from the rate control unit 414.

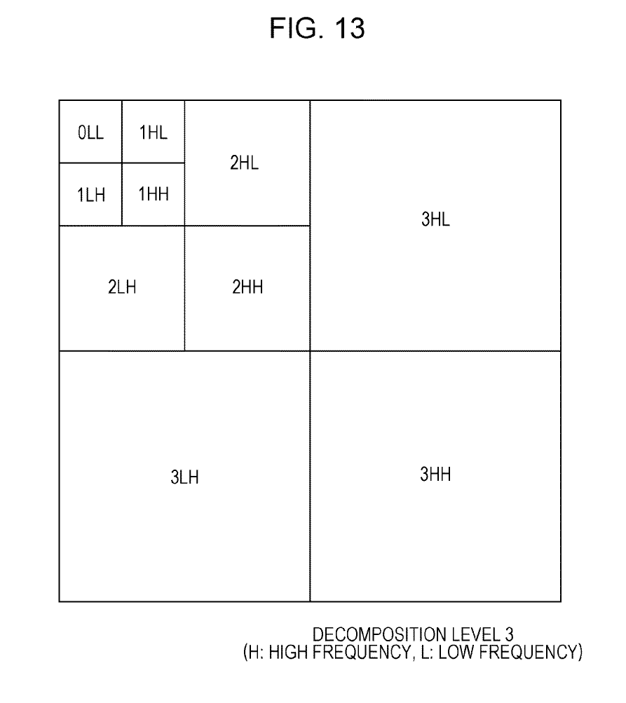

The processing performed by the wavelet transform unit 410 will be described in more detail. First, the wavelet transform will be described briefly. As schematically illustrated in FIG. 13, in the wavelet transform performed on the image data, processing for decomposing the image data into a high-spatial-frequency band and a low-spatial-frequency band is recursively repeated on low-spatial-frequency band data resulting from the decomposition. Through the processing, the data in the low-spatial-frequency band are refined into a smaller region, thereby making it possible to perform efficient compression coding.

FIG. 13 illustrates an example of a case in which processing for decomposing a lowest-frequency-component region in image data into a low-frequency-component region L and a high-frequency-component region H is repeated three times, and decomposition level 3 is reached. In FIG. 13, “L” and “H” indicate low-frequency components and high-frequency components, respectively, with “L” or “H” on the left side indicating a band resulting from division in the horizontal direction, and “L” or “H” on the right side indicating a band resulting from division in the vertical direction. The numeral preceding “L” and “H” also indicates the decomposition level in the corresponding region.

As is apparent from the example illustrated in FIG. 13, the processing is performed in a stepwise manner from the lower right region on the screen toward the upper left region to refine the low-frequency components. That is, in the example illustrated in FIG. 13, the lower right region resulting from division of the screen is a region 3HH where the amount of low-frequency components is the smallest (i.e., the amount of high-frequency components is the largest), and the upper left one of the four regions on the screen is subdivided into four regions, the upper left one of which is further subdivided into four regions. The region at the upper left corner is a region 0LL containing the largest amount of low-frequency components.

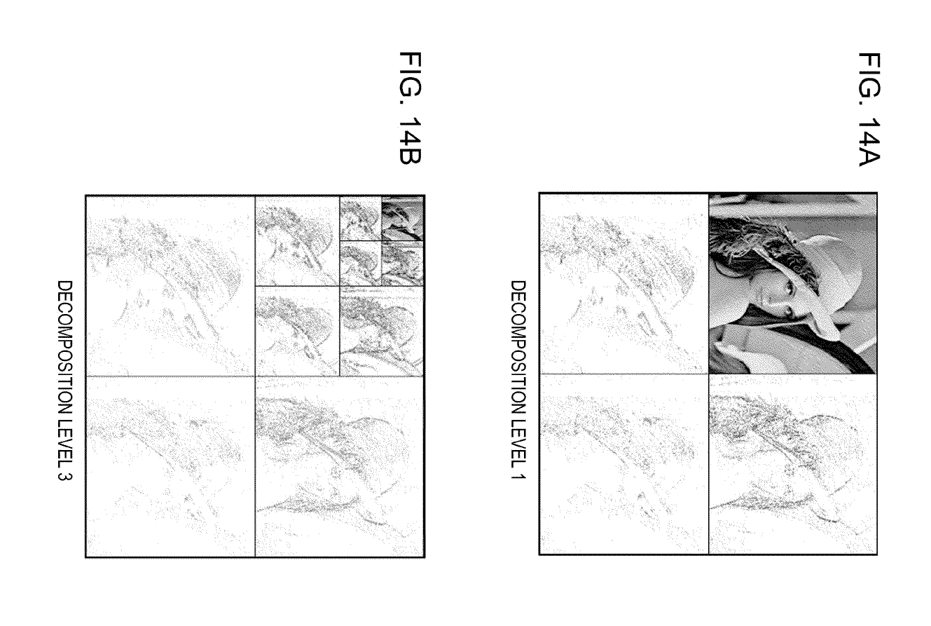

The reason why the low-frequency components are repeatedly transformed and decomposed is that energy of the image is concentrated in low-frequency components. This can also be understood from the process in which, as the decomposition level progresses, for example, from a state at decomposition level 1 (one example of which is illustrated in FIG. 14A) to a state at decomposition level 3 (one example of which is illustrated in FIG. 14B), sub-bands are formed as illustrated in FIG. 14B. For example, the decomposition level in the wavelet transform in FIG. 13 is 3, which results in the formation of ten sub-bands.

The wavelet transform unit 410 typically uses a filter bank including low-pass filters and high-pass filters to perform processing as described above. Since digital filters typically have an impulse response with a length of multiple taps, i.e., a filter coefficient, input image data or coefficient data that is sufficient to allow for filtering processing is to be buffered in advance. When the wavelet transform is performed in multiple stages, wavelet-transformed coefficients generated at a previous stage are also to be buffered in a sufficient number that allows for the filtering processing.

Next, a method using a 5×3 filter will be described as a specific example of the wavelet transform based on this encoding scheme. The method using a 5×3 filter is also employed in the JPEG 2000 standard described above in the related art and is advantageous in that the wavelet transform can be performed with fewer filter taps.

An impulse response (Z transform representation) of the 5×3 filter is constituted by a low-pass filter H₀(z) and a high-pass filter H₁(z), as noted in equations (1) and (2) below. Equations (1) and (2) show that the low-pass filter Hₒ(z) has five taps and the high-pass filter H₁(z) has three taps.

H₀(z)=(−1+2z⁻¹+6z⁻²+2z⁻³−z⁻⁴)/8 (1)

H₁(z)=(−1+2z⁻¹−z⁻²)/2 (2)

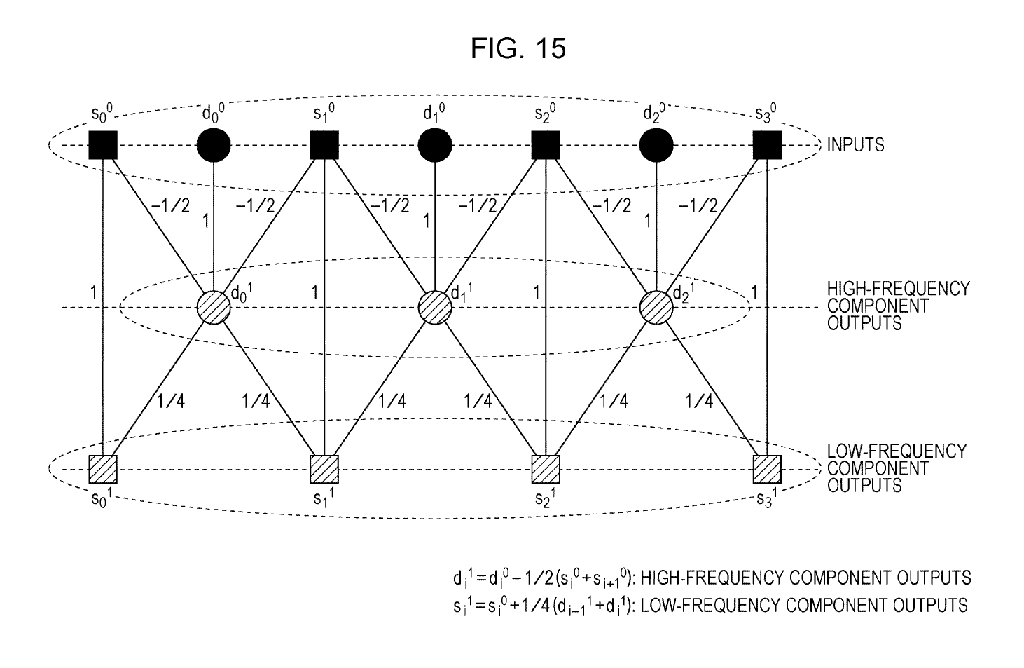

According to equations (1) and (2), low-frequency-component and high-frequency-component coefficients can be directly determined. In this case, use of a lifting technique makes it possible to reduce the amount of calculation in the filtering processing. Processing at the analysis filter side for performing the wavelet transform when a lifting technique is applied to a 5×3 filter will be briefly described with reference to FIG. 15.

In FIG. 15, the top portion, the middle portion, and the bottom portion indicate a pixel row of an input image, high-frequency-component outputs, and low-frequency-component outputs, respectively. The top portion may indicate coefficients obtained by previous filtering processing, instead of a pixel row of an input image. In this case, however, the top portion is assumed to indicate a pixel row of an input image. Solid squares (▪) indicate even-numbered pixels or lines (the first one is the zeroth pixel or line), and solid circles () indicate odd-numbered pixels or lines.

First, at a first phase, high-frequency-component coefficients dᵢ¹ are generated from the input pixel row in accordance with equation (3):

dᵢ¹=dᵢ⁰−½(sᵢ⁰+sᵢ₊₁⁰) (3)

Next, at a second phase, the generated high-frequency-component coefficients and the odd-numbered pixels of the input image are used to generate low-frequency-component coefficients sᵢ¹ in accordance with equation (4):

sᵢ¹=sᵢ⁰+¼(dᵢ₋₁¹+dᵢ¹) (4)

At the analysis filter side, filtering processing is performed as such to decompose the pixel data of the input image into low-frequency components and high-frequency components.

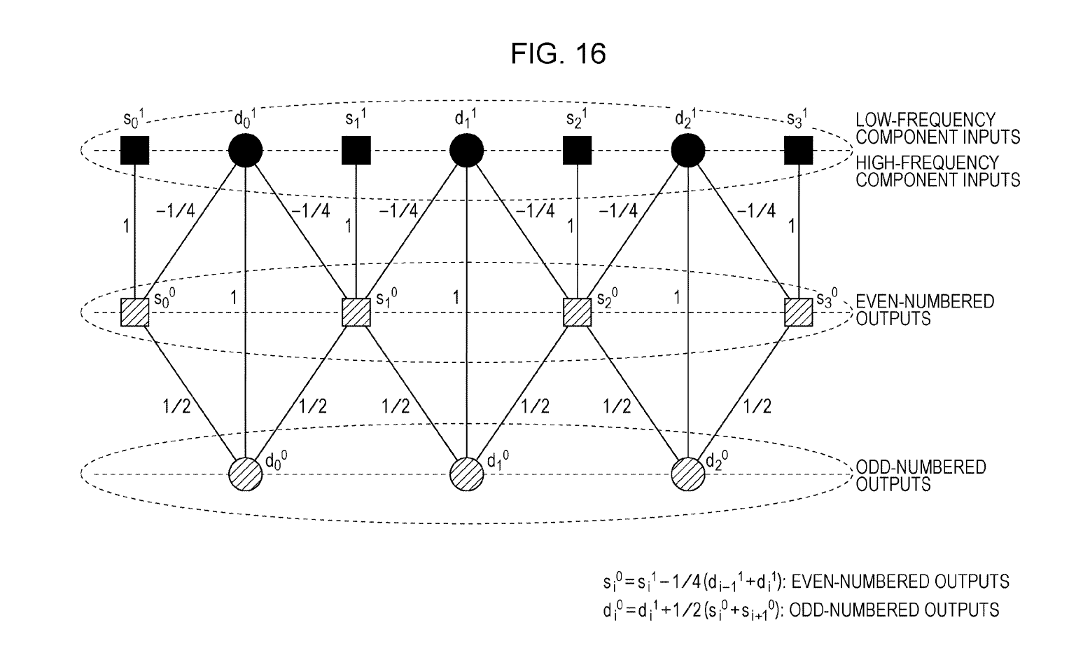

Next, processing at a synthesis filter side for performing an inverse wavelet transform for reconstructing the coefficients generated by the wavelet transform will be briefly described with reference to FIG. 16. FIG. 16 corresponds to FIG. 15 described above and illustrates an example in which a 5×3 filter is used and the lifting technique is applied. In FIG. 16, the top portion indicates input coefficients generated by the wavelet transform, solid circles () indicate high-frequency-component coefficients, and solid squares (▪) indicate of low-frequency-component coefficients.

First, at a first phase, even-numbered coefficients sᵢ⁰ (the first one is the zeroth coefficient) are generated from the input low-frequency-component and high-frequency-component coefficients in accordance with equation (5):

sᵢ⁰=sᵢ¹−¼(dᵢ₋₁¹+dᵢ¹) (5)

Next, at a second phase, odd-numbered coefficients dᵢ⁰ are generated from the even-numbered coefficients sᵢ⁰ generated at the first phase described above and the input high-frequency-component coefficients dᵢ¹ in accordance with equation (6):

dᵢ⁰=)dᵢ¹+½(sᵢ⁰+sᵢ₊₁⁰) (6)

At the synthesis filter side, filtering processing is performed as such to synthesize the low-frequency-component coefficients and the high-frequency-component coefficients to perform the inverse wavelet transform.

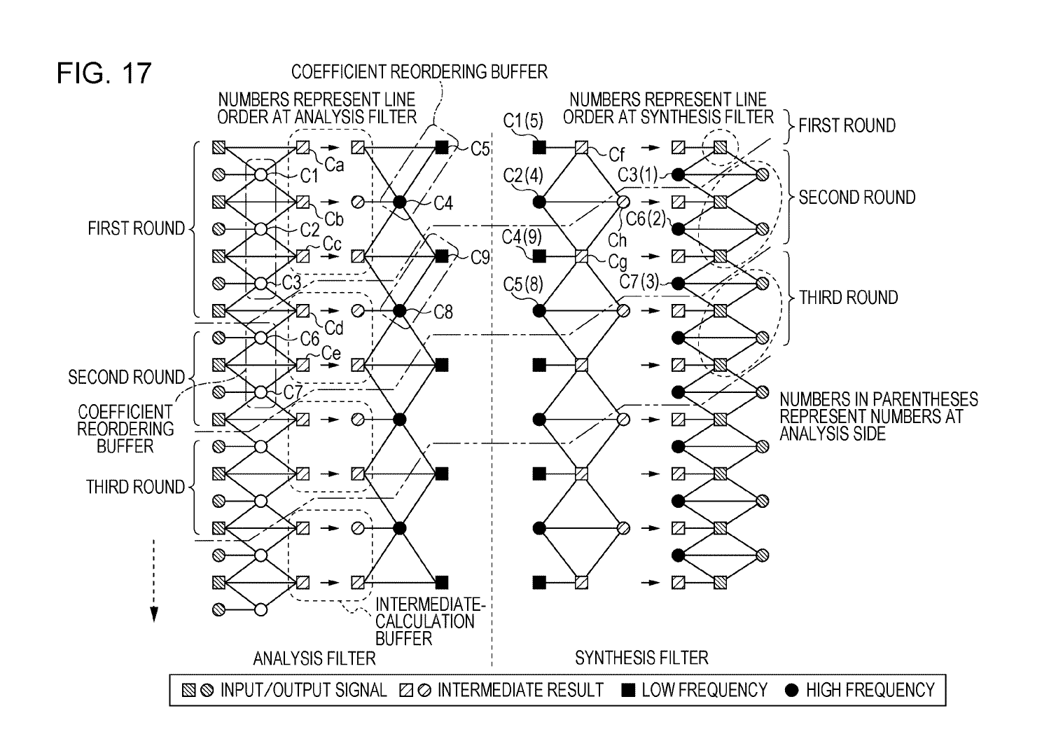

The method for the wavelet transform will be described next. FIG. 17 illustrates an example in which the lifting-based filtering processing using the 5×3 filter described above with reference to FIG. 15 is executed up to decomposition level 2. A portion denoted as “analysis filter” at the left side in FIG. 17 represents one analysis filter of the wavelet transform unit 410 in the image encoding unit 312. The portion denoted as “synthesis filter” at the right side in FIG. 17 represents a filter of an inverse-wavelet-transform unit (described below) in the image decoding unit 331.

In the following description, it is assumed that, for example, in a display device or the like, pixels are scanned from the left end of a screen to the right end thereof, starting at the pixel at the upper left corner, to constitute one line and scanning for each line is performed from the upper end of the screen to the lower end thereof to constitute one screen.

In FIG. 17, the left end column is depicted as a column in which pixel data at positions corresponding to lines in original image data are arranged in a vertical direction. Thus, the wavelet transform unit 410 performs the filtering processing by using a vertical filter to vertically scan the pixels on the screen. The first to third columns from the left end represent filtering processing at decomposition level 1, and the fourth to sixth columns represent filtering processing at decomposition level 2. The second column from the left end represents high-frequency-component outputs based on the pixels in the original image data at the left end, and the third column from the left end represents low-frequency-component outputs based on the original image data and the high-frequency-component outputs. As depicted in the fourth to sixth columns from the left end, the filtering processing at decomposition level 2 is performed on the outputs of the filtering processing at decomposition level 1.

In the filtering processing at decomposition level 1, as the filtering processing at the first phase, high-frequency component coefficient data are determined based on the pixels of the original image data, and as the filtering processing at the second phase, low-frequency-component coefficient data are determined based on the high-frequency-component coefficient data determined in the filtering processing at the first phase and the pixels of the original image data. One example of the filtering processing at decomposition level 1 is depicted in the first to third columns at the left side (at the analysis filter side) in FIG. 17. The determined high-frequency-component coefficient data are stored in the coefficient-reordering buffer unit 412 illustrated FIG. 12. The determined low-frequency-component coefficient data are stored in the intermediate-calculation buffer unit 411.

In FIG. 17, the coefficient-reordering buffer unit 412 is indicated as portions surrounded by dashed-dotted lines, and the intermediate-calculation buffer unit 411 is indicated as portions surrounded by dotted lines.

The filtering processing at decomposition level 2 is performed based on the result of the filtering processing at decomposition level 1, the result being stored in the intermediate-calculation buffer unit 411. In the filtering processing at decomposition level 2, filtering processing similar to that at decomposition level 1 is performed assuming that the coefficient data determined as the low-frequency component coefficients in the filtering processing at decomposition level 1 are coefficient data containing low-frequency components and high-frequency components. High-frequency-component coefficient data and low-frequency component coefficient data determined in the filtering processing at decomposition level 2 are stored in the coefficient-reordering buffer unit 412 illustrated in FIG. 12.

The wavelet transform unit 410 performs filtering processing as described above in each of the screen horizontal direction and the screen vertical direction. For example, the wavelet transform unit 410 first performs the filtering processing at decomposition level 1 in the horizontal direction and stores the generated high-frequency-component and low-frequency-component coefficient data in the intermediate-calculation buffer unit 411. The wavelet transform unit 410 then performs the filtering processing at decomposition level 1 in the vertical direction on the coefficient data stored in the intermediate-calculation buffer unit 411. As a result of the filtering processing at decomposition level 1 in the horizontal and vertical directions, four regions, i.e., regions HH, HL, LH, and LL, are formed. The regions HH and HL contain the coefficient data obtained by further decomposing the high-frequency components into high-frequency components and low-frequency components, and the regions LH and LL contain the coefficient data obtained by further decomposing the low-frequency components into high-frequency components and low-frequency components.

Then, at decomposition level 2, the filtering processing is performed on the low-frequency component coefficient data, generated at decomposition level 1, in each of the horizontal direction and the vertical direction. That is, at decomposition level 2, the region LL formed as a result of the division at decomposition level 1 is further divided into four regions, so that regions HH, HL, LH, and LL are additionally formed in that region LL.

In this encoding scheme, the filtering processing involving the wavelet transform is divided into multiple processes, each for multiple lines, with respect to the vertical direction of the screen, and the processes are separately performed in multiple stages. In the example in FIG. 17, in a first round of the processing starting at the first line on the screen, the filtering processing is performed on seven lines, and in second and subsequent rounds of the processing starting at the eighth line, the filtering processing is performed on four lines at a time. This number of lines is based on the number of lines used for generation of lowest-frequency components for one line after decomposition into two frequency components, i.e., high-frequency components and low-frequency components.

A collection of lines including other sub-bands, the collection being used for generating one line of the lowest-frequency components (i.e., coefficient data for one line of the lowest-frequency component sub-band), is hereinafter referred to as a “line block (or a precinct)”. The term “line” as used herein refers to pixel data or coefficient data for one row formed in a picture or field corresponding to image data before the wavelet transform or formed in each sub-band. That is, the line block (or precinct) refers to, in the original image data before the wavelet transform, a pixel data group for a number of lines used for generating coefficient data for one line of the lowest-frequency component sub-band after the wavelet transform or a coefficient data group of each sub-band obtained by performing the wavelet transform on the pixel data group.

In the example in FIG. 17, coefficient C5 obtained from the result of the filtering processing at decomposition level 2 is determined based on coefficient C4 and coefficient Ca stored in the intermediate-calculation buffer unit 411, and the coefficient C4 is determined based on coefficients Ca, Cb, and Cc stored in the intermediate-calculation buffer unit 411. In addition, the coefficient Cc is determined based on coefficients C2 and C3 stored in the coefficient-reordering buffer unit 412 and the pixel data of the fifth line. The coefficient C3 is also determined based on the pixel data of the fifth to seventh lines. Thus, in order to obtain the low-frequency component coefficient C5 at decomposition level 2, the pixel data of the first to seventh lines are used.

In contrast, in the second and subsequent rounds of the filtering processing, the coefficient data already determined in the previous round of the filtering processing and stored in the coefficient-reordering buffer unit 412 can be used. Thus, the number of lines used can be reduced.

That is, in the example in FIG. 17, of the low-frequency component coefficients obtained from the result of the filtering processing at decomposition level 2, coefficient C9, which is the coefficient next to the coefficient C5, is determined based on the coefficient C4, coefficient C8, and the coefficient Cc stored in the intermediate-calculation buffer unit 411. The coefficient C4 has already been determined in the above-described first round of the filtering processing and is stored in the coefficient-reordering buffer unit 412. Similarly, the coefficient Cc has already been determined in the above-described first round of the filtering processing and is stored in the intermediate-calculation buffer unit 411. Thus, in the second round of the filtering processing, only the filtering processing for determining the coefficient C8 is newly performed. This new filtering processing is performed further using the eighth to eleventh lines.

As such, in the second and subsequent rounds of the filtering processing, the data determined in the previous round of the filtering processing and stored in the intermediate-calculation buffer unit 411 and the coefficient-reordering buffer unit 412 can be used, so that the processing can be performed on four lines at a time.

When the number of lines on the screen does not match the number of lines for the encoding, the lines in the original image data are duplicated to a predetermined number of lines that matches the number of lines for the encoding to perform the filtering processing.

In the present technology, the filtering processing that can obtain coefficient data for one line of the lowest-frequency components is performed on the lines on the entire screen in multiple stages (i.e., for each of the line blocks), as described above, details of which are described below. Such an implementation makes it possible to obtain a decoded image with low delay when encoded data are transmitted.

The wavelet transform involves a first buffer used for executing the wavelet transform itself and a second buffer for storing coefficients generated while the processing is executed up to a predetermined decomposition level. The first buffer corresponds to the intermediate-calculation buffer unit 411 and is denoted by portions surrounded by dotted lines in FIG. 17. The second buffer corresponds to the coefficient-reordering buffer unit 412 and is denoted by portions surrounded by dashed-dotted lines in FIG. 17. Since the coefficients stored in the second buffer are used for decoding, they are subjected to entropy encoding processing performed at a subsequent stage.

Processing in the coefficient reordering unit 413 will now be described. As described above, the coefficient data determined by the wavelet transform unit 410 are stored in the coefficient-reordering buffer unit 412, are reordered by the coefficient reordering unit 413, and are sent out to the entropy encoding unit 415.

As described earlier, in the wavelet transform, coefficients are generated in order from the high-frequency component side to the low-frequency component side. In the example in FIG. 17, in the first round, the filtering processing at decomposition level 1 is performed on the pixel data of the original image to sequentially generate the high-frequency-component coefficients C1, C2, and C3. Then, the filtering processing at decomposition level 2 is performed on the low-frequency component coefficient data obtained in the filtering processing at decomposition level 1, to sequentially generate the low-frequency component coefficients C4 and C5. That is, in the first round, coefficient data are sequentially generated in the order of the coefficients C1, C2, C3, C4, and C5. The order in which the coefficient data are generated is typically set to that order (i.e., from high frequencies to low frequencies) in accordance with the principle of the wavelet transform.

In turn, at the decoding side, an image is generated and output starting from low-frequency components first, in order to enable instantaneous decoding with low delay. Accordingly, it is desirable that the coefficient data generated by the encoding side be reordered in order from the lowest-frequency component side to the high-frequency component side and be supplied to the decoding side.

A more specific description will be given with reference to FIG. 17. The right side in FIG. 17 depicts the synthesis filter side that performs an inverse wavelet transform. At the decoding side, a first round of synthesis processing (i.e., inverse wavelet transform processing) involving the first line in the output image data is performed using the lowest-frequency-component coefficients C4 and C5, generated in the first round of the filtering processing at the encoding side, and the coefficient C1.

That is, in the first round of the synthesis processing, the coefficient data are supplied from the encoding side to the decoding side in the order of coefficients C5, C4, and C1, and at the decoding side, in processing at synthesis level 2, which involves synthesis processing corresponding to decomposition level 2, the synthesis processing is performed on the coefficients C5 and C4 to generate coefficient Cf, which is then stored in a buffer. In the processing at synthesis level 1, which involves synthesis processing corresponding to decomposition level 1, the synthesis processing is performed on the coefficients Cf and C1, and the first line is output.

As such, for the first round of the synthesis processing, the coefficient data generated in the order of the coefficients C1, C2, C3, C4, and C5 and stored in the coefficient-reordering buffer unit 412 at the encoding side are reordered in the order of the coefficients C5, C4, C1, . . . , and the reordered coefficients are supplied to the decoding side.

At the synthesis filter side depicted at the right side in FIG. 17, with respect to the coefficients supplied from the encoding side, the numbers of the coefficients at the encoding side are indicated in parentheses, and the numbers in line order at the synthesis filter are indicated outside the parentheses. For example, coefficient C1(5) is the coefficient C5 at the analysis filter side at the left side in FIG. 17 and indicates the first line at the synthesis filter side.

The synthesis processing performed at the decoding side by using the coefficient data generated in the second and subsequent rounds of the filtering processing at the encoding side can be performed using the coefficient data synthesized in the previous synthesis processing or the coefficient data supplied from the encoding side. In the example in FIG. 17, the second round of the synthesis processing performed at the decoding side by using the low-frequency component coefficients C8 and C9 generated in the second round of the filtering processing at the encoding side further uses the coefficients C2 and C3 generated in the first round of the filtering processing at the encoding side, to thereby decode the second to fifth lines.

That is, in the second round of the synthesis processing, the coefficient data are supplied from the encoding side to the decoding side in the order of the coefficient C9, C8, C2, and C3. At the decoding side, in processing at synthesis level 2, the coefficients C8 and C9 and the coefficient C4 supplied from the encoding side during the first round of the synthesis processing are used to generate coefficient Cg, which is then stored in the buffer. The coefficient Cg, the above-described coefficient C4, and the coefficient Cf generated in the first round of the synthesis processing and stored in the buffer are used to generate coefficient Ch, which is then stored in the buffer.

Then, in processing at synthesis level 1, the coefficients Cg and Ch generated in the processing at synthesis level 2 and stored in the buffer, the coefficient C2 (denoted as coefficient C6(2) in the synthesis filter) supplied from the encoding side, and the coefficient C3 (denoted as coefficient C7(3) in the synthesis filter) supplied from the encoding side are used to perform synthesis processing to decode the second to fifth lines.

As such, for the second round of the synthesis processing, the coefficient data generated at the encoding side in the order of the coefficients C2, C3, (C4, C5), C6, C7, C8, and C9 are reordered in the order of the coefficients C9, C8, C2, C3, . . . , and the reordered coefficient data are supplied to the decoding side.

For the third and subsequent rounds of the synthesis processing, the coefficient data stored in the coefficient-reordering buffer unit 412 are similarly reordered in a predetermined order and are supplied to the decoding side, at which four lines are decoded at a time.

In the synthesis processing at the decoding side which corresponds to the filtering processing at the encoding side which involves the lower-end line on the screen (this filtering processing at the encoding side will hereinafter be referred to as “last round”), all of the coefficient data generated in the processing up to this point and stored in the buffer are output. Consequently, the number of output lines increases. In the example in FIG. 17, eight lines are output in the last round.

The coefficient reordering unit 413 performs the above-described coefficient-data reordering processing, for example, by setting read addresses, used for reading the coefficient data stored in the coefficient-reordering buffer unit 412, to a predetermined order.

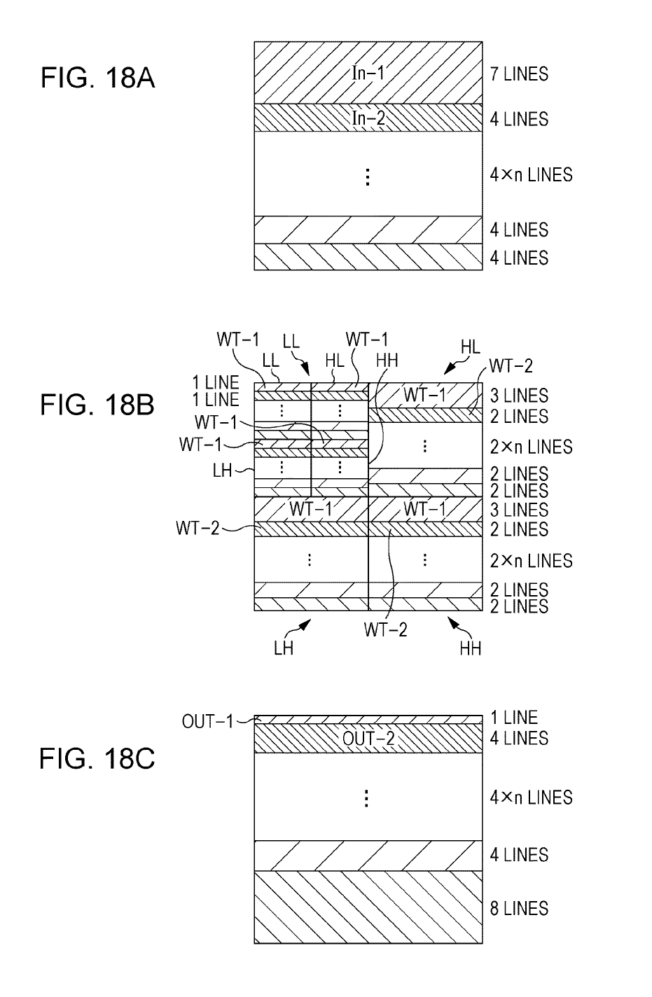

The above-described processing will now be described more specifically with reference to FIGS. 18A to 18C. FIGS. 18A to 18C illustrate an example in which, filtering processing involving a wavelet transform is performed up to decomposition level 2 by using a 5×3 filter. As exemplified in FIG. 18A, the wavelet transform unit 410 performs a first round of the filtering processing on the first to seventh lines (In-1 in FIG. 18A) of input image data in each of the horizontal and vertical directions.

In processing at decomposition level 1 in the first round of the filtering processing, coefficient data for three lines, i.e., the coefficients C1, C2, and C3, are generated, and are arranged in corresponding regions HH, HL, and LH (WT-1 in FIG. 18B) formed at decomposition level 1, as exemplified in FIG. 18B.

In filtering processing in the horizontal and vertical directions at decomposition level 2, a region LL formed at decomposition level 1 is further divided into four regions. As to the coefficients C5 and C4 generated at decomposition level 2, in the region LL formed at decomposition level 1, one line containing the coefficient C5 is arranged in a region LL, and one line containing the coefficient C4 is arranged in each of the regions HH, HL, and LH.

In the second and subsequent rounds of the filtering processing performed by the wavelet transform unit 410, the filter processing is performed on four lines (In-2 . . . , in FIG. 18A) at a time, so that coefficient data for two lines are generated at a time at decomposition level 1 (WT-2 in FIG. 18B), and coefficient data for one line are generated at a time at decomposition level 2.

In the example of the second round of the filtering processing in FIG. 17, coefficient data for two lines, i.e., coefficients C6 and C7, are generated in the filtering processing at decomposition level 1 and are arranged subsequent to the coefficient data, generated in the first round of the filtering processing, in regions HH, HL, and LH formed at decomposition level 1, as exemplified in FIG. 18B. Similarly, in the region LL formed at decomposition level 1, the coefficient C9 for one line generated in the filtering processing at decomposition level 2 is arranged in the region LL, and the coefficient C8 for one line is arranged in each of regions HH, HL and LH.

When the wavelet-transformed data is decoded as in FIG. 18B, a first line resulting from the first round of the synthesis processing at the decoding side is output (Out-1 in FIG. 18C) with respect to the first round of the filtering processing at the encoding side on the first line to seventh line, as exemplified in FIG. 18C. Thereafter, with respect to the second round of the filtering processing to the round of filtering processing immediately before the last round at the encoding side, four lines are output at the decoding side at a time (Out-2 . . . , in FIG. 18C). With respect to the last round of the filtering processing at the encoding side, eight lines are output at the decoding side.

The coefficient data generated in order from the high-frequency component side to the low-frequency component side by the wavelet transform unit 410 are sequentially stored in the coefficient-reordering buffer unit 412. When coefficient data are accumulated in the coefficient-reordering buffer unit 412 to such a degree the coefficient data can be reordered, the coefficient reordering unit 413 reorders the coefficient data in the order used for the synthesis processing and reads the reordered coefficient data from the coefficient-reordering buffer unit 412. The read coefficient data are sequentially supplied to the entropy encoding unit 415.

With respect to the supplied coefficient data, the entropy encoding unit 415 controls the encoding operation so that the bit rate of output data reaches a target bit rate, on the basis of a control signal supplied from the rate control unit 414, to perform entropy encoding. Encoded data resulting from the entropy encoding are supplied to the decoding side. Examples of a possible scheme for the encoding include Huffman coding and arithmetic coding, which are typical techniques. Needless to say, the encoding scheme is not limited to these examples, and any other encoding scheme that allows for reversible encoding processing may also be used.

The entropy encoding unit 415 may be adapted so that it first quantizes the coefficient data read from the coefficient reordering unit 413 and performs source coding processing, such as Huffman coding or arithmetic coding, on the resulting quantized coefficients. With such an implementation, a further improvement in the compression effect can be expected. Any method may be used for the quantization. For example, a typical scheme, specifically, a scheme for dividing coefficient data W by a quantization step size Δ, as noted in equation (7) below, may be used.

Quantized Coefficient=W/Δ (7)

In this case, the wavelet transform unit 410 performs the wavelet transform for each plurality of lines (i.e., for each line block) in image data, as described above with reference to FIGS. 17 and 18A to 18C. The encoded data resulting from the encoding by the entropy encoding unit 415 is output for each line block. That is, when the processing is performed up to decomposition level 2 through use of the 5×3 filter, data for one line in one screen are initially output, data for four lines are output at a time in each of the second round to the round immediately before the last round, and data for eight lines are output in the last round.

When the coefficient data reordered by the coefficient reordering unit 413 are to be subjected to the entropy encoding, for example, when the line of the first coefficient C5 is to be subjected to entropy encoding in the first round of the filtering processing illustrated in FIG. 17, no past line exist, i.e., a line for which coefficient data have already been generated does not. Thus, in this case, only that one line is subjected to the entropy encoding. In contrast, when the line of the coefficient C1 is to be encoded, the lines of the coefficients C5 and C4 have become past lines. Since these adjacent lines are assumed to be constituted of similar data, it is advantageous to subject the multiple lines to the entropy encoding at once.

Although an example in which the wavelet transform unit 410 performs filtering processing involving a wavelet transform by using a 5×3 filter has been described above, the present technology is not limited to that example. For instance, the wavelet transform unit 410 can use a filter having a larger number of taps, such as a 9×7 filter. In this case, when the number of taps in a filter is large, the number of lines accumulated in the filter also increases, and thus the delay time from when image data is input until encoded data is output increases.

Although a case in which the decomposition level for the wavelet transform is decomposition level 2 has been described above for the sake of description, the present technology is not limited to that example, and the decomposition level may be further increased. A higher decomposition level can realize a higher compression ratio.

For example, in a wavelet transform, the filtering processing is generally repeated up to decomposition level 4. A higher decomposition level means that the delay time also increases.

Accordingly, it is preferable that the number of taps in the filter and the decomposition level be determined in accordance with the delay time and the decoded-image quality desired for the advertisement presenting system 300. The number of taps in the filter and the decomposition level can also be set to be adaptively selectable, rather than being set to fixed values.

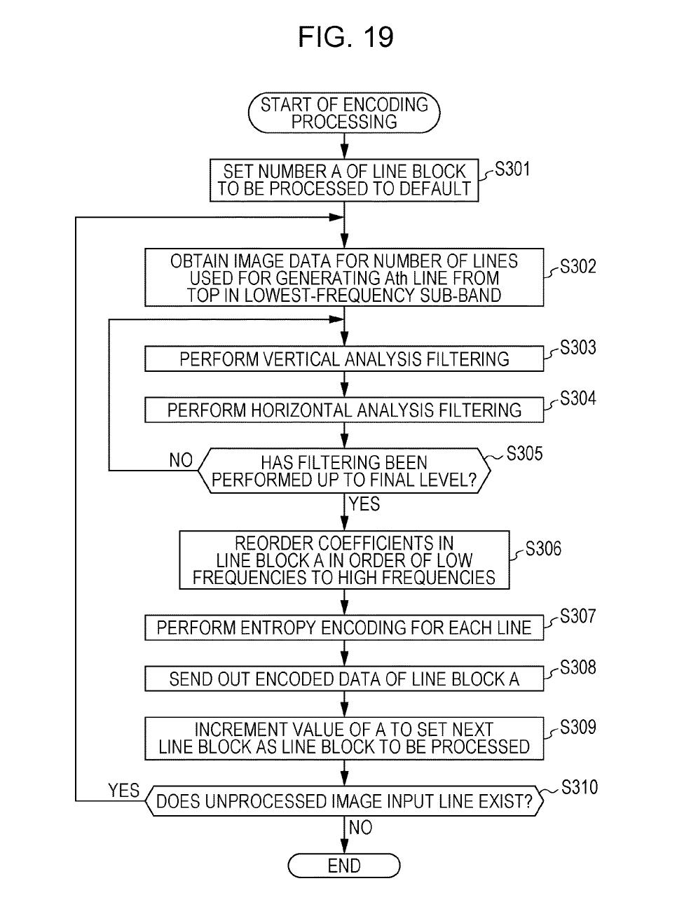

Next, an example of a specific flow of the overall encoding processing performed by the image encoding unit 312 will be described with reference to a flowchart illustrated in FIG. 19.

When the encoding processing is started, the wavelet transform unit 410 sets the number A of a line block to be processed to a default in step S301. In a typical case, the number A is set to “1”. When the setting is completed, in step S302, the wavelet transform unit 410 obtains image data for a number of lines (i.e., one line block) used for generating the Ath line from the top in the lowest-frequency sub-band. In step S303, the wavelet transform unit 410 performs vertical analysis filtering processing, which involves analysis filtering processing on image data arranged in the screen vertical direction, on the image data. In step S304, the wavelet transform unit 410 performs horizontal analysis filtering processing, which involves analysis filtering processing on image data arranged in the screen horizontal direction, on the image data.

In step S305, the wavelet transform unit 410 determines whether or not the analysis filtering processing has been performed up to the final level. Upon determining that the decomposition level does not reach the final level, the process returns to step S303 in which the wavelet transform unit 410 repeats the analysis filtering processing in steps S303 and S304 at the current decomposition level.

When it is determined in step S305 that the analysis filtering processing has been performed up to the final level, the process of the wavelet transform unit 410 proceeds to step S306.

In step S306, the coefficient reordering unit 413 reorders the coefficients in line block A (the Ath line block from the top in a picture (or a field in the case of an interlace system)) in an order of low frequencies to high frequencies. In step S307, the entropy encoding unit 415 performs entropy encoding on the coefficients for each line. Upon completing the entropy encoding, the entropy encoding unit 415 sends out encoded data of line block A to outside in step S308.

In step S309, the wavelet transform unit 410 increments the value of the number A by “1” to set the next line block as a line block to be processed. In step S310, the wavelet transform unit 410 determines whether or not an unprocessed image input line exists in the picture to be processed (or the field to be processed, in the case of the interlace system). When it is determined that any unprocessed image input line exists, the process returns to step S302. The wavelet transform unit 410 then repeats the process in step S302 and the subsequent processes on the new line block to be processed.

The processes in steps S302 to S310 are repeatedly executed as described above, so that each line block is encoded. When it is determined in step S310 that no unprocessed image input line exists, the wavelet transform unit 410 ends the encoding processing on the picture (or the field, in the case of the interlace system). Encoding processing is then newly started on a next picture (or a next field, in the case of the interlace system).

For a wavelet transform method in the related art, first, horizontal analysis filtering processing is performed on an entire picture (or an entire field in the case of an interlace system) and then vertical analysis filtering processing is performed on the resulting entire picture (or the resulting entire field) to obtain low-frequency components. Then, similar horizontal analysis filtering processing and vertical analysis filtering processing are sequentially performed on all of the low-frequency components. As described above, the analysis filtering processing is recursively repeated until the decomposition level reaches the final level. Thus, the results of the analysis filtering processing are to be stored in a buffer. More specifically, the results of the filtering on an entire picture (an entire field, in the case of the interlace system) or on all of the low-frequency components at the decomposition level at the current point are to be stored in the buffer. Consequently, a large memory capacity is used (i.e., the amount of data stored is large).

In addition, in this case, unless the entire wavelet transform is completed on the picture (the field, in the case of the interlace system), the coefficient reordering and the entropy encoding at the subsequent stage are not performed and thus the delay time increases.

In contrast, in the case of the wavelet transform unit 410 in the image encoding unit 312, the vertical analysis filtering processing and the horizontal analysis filtering processing are performed for each line block in sequence up to the final level, as described above. Thus, compared with the method in the related art, the amount of data to be stored (buffered) at once (at the same time) is small, thereby making it possible to considerably reduce the amount of memory to be prepared in the buffer. Additionally, since the analysis filtering processing is performed up to the final level, processing, such as the coefficient reordering and entropy encoding at the subsequent stages, can also be performed (i.e., the coefficient reordering and entropy encoding can be performed for each line block). Thus, compared with the method in the related art, the delay time can be considerably reduced.

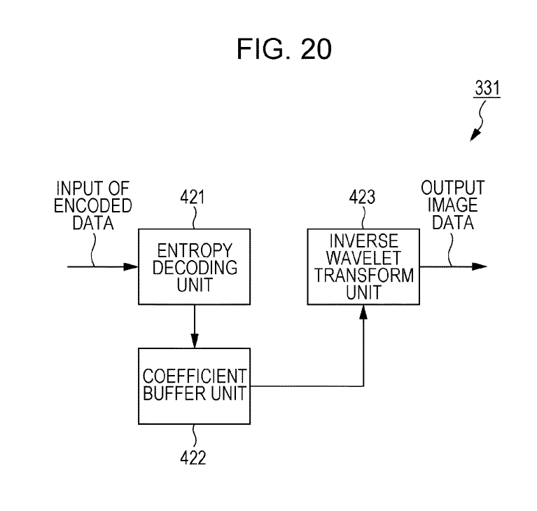

FIG. 20 illustrates the configuration of one example of the image decoding unit 331. The encoded data (“output of encoded data” in FIG. 12) output from the entropy encoding unit 415 in the image encoding unit 312 are supplied to an entropy decoding unit 421 in the image decoding unit 331 in FIG. 20 (“input of encoded data” in FIG. 20), and the resulting entropy codes are decoded, so that the coefficient data are obtained. The coefficient data are stored in a coefficient buffer unit 422. An inverse wavelet transform unit 423 uses the coefficient data, stored in the coefficient buffer unit 422, to perform synthesis filtering processing using a synthesis filter, for example, as described above with reference to FIGS. 16 and 17, and stores the result of the synthesis filtering processing in the coefficient buffer unit 422. The inverse wavelet transform unit 423 repeats the processing in accordance with the decomposition level to obtain decoded image data (i.e., output image data).

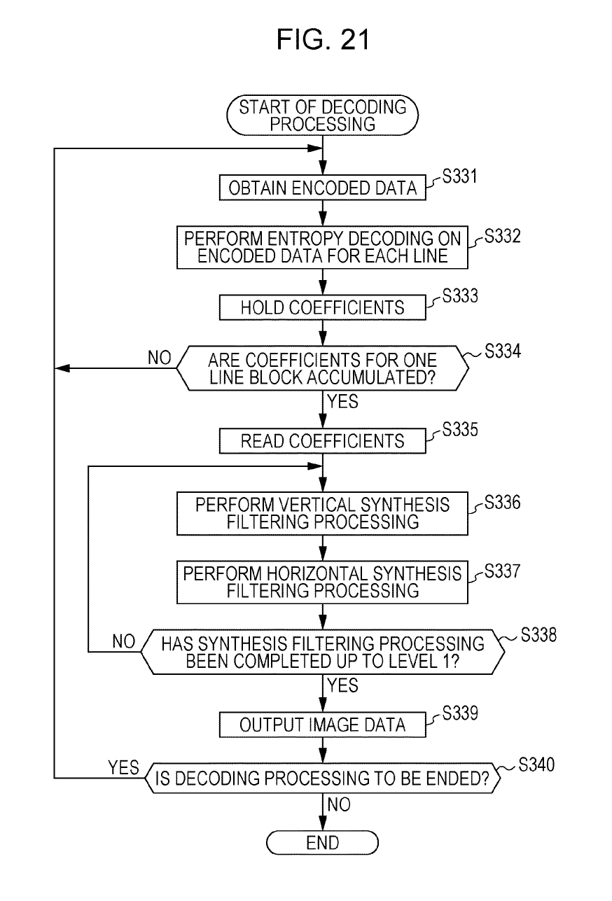

Next, an example of a specific flow of the overall decoding processing performed by the image decoding unit 331 configured as described above will be described with reference to a flowchart in FIG. 21.

When the decoding processing is started, the entropy decoding unit 421 obtains encoded data in step S331 and performs entropy decoding on the encoded data for each line to obtain coefficients in step S332. In step S333, the coefficient buffer unit 422 holds the coefficients obtained in the entropy decoding. In step S334, the inverse wavelet transform unit 423 determines whether or not coefficients for one line block are accumulated in the coefficient buffer unit 422. When it is determined that coefficients for one line block are not accumulated, the process returns to step S331. Then, the process in step S331 and the subsequent processes are executed, and the inverse wavelet transform unit 423 waits until coefficients for one line block are accumulated in the coefficient buffer unit 422.

When it is determined in step S334 that coefficients for one line block are accumulated in the coefficient buffer unit 422, the process of the inverse wavelet transform unit 423 proceeds to step S335. In step S335, the inverse wavelet transform unit 423 reads the coefficients for one line block, the coefficients being held in the coefficient buffer unit 422.

In step S336, the inverse wavelet transform unit 423 performs vertical synthesis filtering processing, which involves synthesis filtering processing on coefficients arranged in the screen vertical direction, on the coefficients read in step S335. In step S337, the inverse wavelet transform unit 423 performs horizontal synthesis filtering processing, which involves synthesis filtering processing on coefficients arranged in the screen horizontal direction, on the read coefficients. In step S338, the inverse wavelet transform unit 423 determines whether or not the synthesis filtering processing has been completed up to level 1 (i.e., a level at which the value of the decomposition level is “1”), that is, whether or not the coefficients are inverse-transformed into the coefficients before the wavelet transform. Upon determining that the level does not reach level 1, the process returns to step S336 and the inverse wavelet transform unit 423 repeats the filtering processing in steps S336 and S337.

When it is determined in step S338 that the inverse transform processing has been completed up to level 1, the process proceeds to step S339 in which the inverse wavelet transform unit 423 outputs image data resulting from the inverse transform processing to outside.

In step S340, the entropy decoding unit 421 determines whether or not the decoding processing is to be ended. Upon determining that encoded data is continuously input and the decoding processing is not to be ended, the process returns to step S331. The entropy decoding unit 421 then repeats the process in step S331 and the subsequent processes. When it is determined in step S340 that the decoding processing is to be ended, for example, in response to ending of the input of encoded data, the entropy decoding unit 421 ends the decoding processing.

In the case of the inverse wavelet transform method in the related art, first, horizontal synthesis filtering processing in the screen horizontal direction is performed on all of the coefficients at the decomposition level and then vertical synthesis filtering processing in the screen vertical direction is performed. That is, each time synthesis filtering processing is performed, a result of the synthesis filtering processing is held in the buffer, during which the buffer holds a result of the synthesis filtering at the decomposition level at the current point and all coefficients at the next decomposition level, meaning that a large amount of memory capacity is involved (the amount of data held is large).

Additionally, in the related art, no image data are output until the entire inverse wavelet transform is completed on a picture (a field, in the case of the interlace system). Consequently, the delay time from the input until the output increases.

In contrast, in the case of the inverse wavelet transform unit 423 in the image decoding unit 331, the vertical synthesis filtering processing and the horizontal synthesis filtering processing are sequentially performed for each line block up to level 1, as described above. Thus, compared with the method in the related art, the amount of data used for buffering at the same time (in the same period of time) is small, which can considerably reduce the amount of memory in the buffer prepared. Furthermore, since the synthesis filtering processing (the inverse wavelet transform processing) is performed up to level 1, image data can be sequentially output (for each line block) before all image data in a picture can be obtained, which can considerably reduce the delay time, compared with the method in the related art.

For example, a central processing unit (CPU, not illustrated) controls the operations of the elements in the image encoding unit 312 and the image decoding unit 331 (i.e., the encoding processing in FIG. 19 and the decoding processing in FIG. 21) in accordance with a predetermined program. The program is pre-stored in, for example, a read only memory (ROM, not illustrated). Such an implementation is merely an example, and a timing signal and/or a control signal may be exchanged between elements, included in the image encoding unit and the image decoding unit, so that they can operate in cooperation with each other. The image encoding unit and the image decoding unit can also be implemented by software that runs on a computer apparatus.

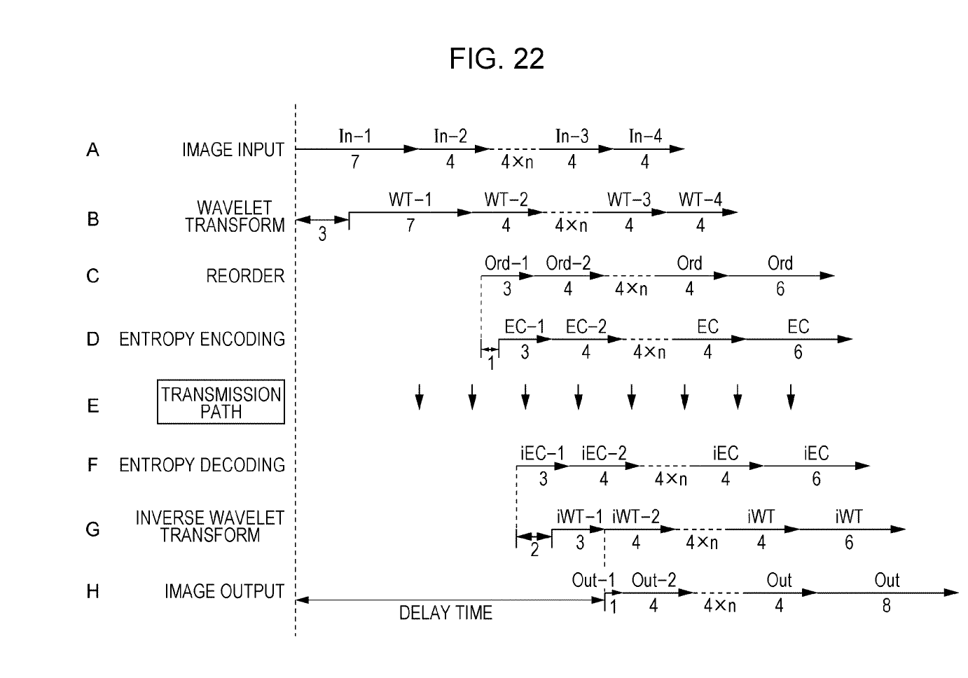

FIG. 22 schematically illustrates an example parallel operation of the elements in the image encoding unit 312 and the image decoding unit 331. FIG. 22 corresponds to FIGS. 18A to C described above. In response to input In-1 (depicted at A in FIG. 22) of image data, the entropy encoding unit 415 performs a first round WT-1 (depicted at B in FIG. 22) of the wavelet transform on the input In-1. As described above with reference to FIG. 17, the first round WT-1 of the wavelet transform is started when the first three lines are input, so that the coefficient C1 is generated. That is, a delay for the three lines occurs from when the image data In-1 is input until the first round WT-1 of the wavelet transform is started.

The coefficient data is stored in the coefficient-reordering buffer unit 412. Thereafter, the input image data is subjected to the wavelet transform, and upon completion of the first round of the processing, the process directly proceeds to a second round WT-2 of the wavelet transform.

In parallel with input In-2 of the image data for the second round WT-2 of the wavelet transform and the processing of the second round WT-2 of the wavelet transform, the coefficient reordering unit 413 executes reordering Ord-1 of three coefficients, i.e., the coefficient C1, C4, and C5 (as depicted at C in FIG. 22).

The delay from when the wavelet transform WT-1 is ended until the reordering Ord-1 is started is a delay based on the apparatus or system configuration, rather than an inherent delay involved in the encoding processing. Examples of the delay based on the apparatus or system configuration include a delay involved in transmission of a control signal for instructing the coefficient reordering unit 413 to perform the reordering processing, a delay involved in starting the processing in the coefficient reordering unit 413 in response to the control signal, and a delay involved in program processing.

The coefficient data are read from the coefficient-reordering buffer unit 412 in the order in which the reordering is completed, are supplied to the entropy encoding unit 415, and are subjected to entropy encoding EC-1 (as depicted at D in FIG. 22). The entropy encoding EC-1 can be started without waiting for the completion of reordering of all of the three coefficients, i.e., the coefficient C1, C4, and C5. For example, at a point when the reordering of the coefficient C5 in one line which is initially output is completed, the entropy encoding on the coefficient C5 can be started. In this case, the delay from when the processing of the reordering Ord-1 is started until the processing of the entropy encoding EC-1 is started corresponds to one line.

The encoded data resulting from the entropy encoding EC-1 performed by the entropy encoding unit 415 are transmitted to the image decoding unit 331 through some type of transmission path (as depicted at E in FIG. 22). One possible example of the transmission path through which the encoded data are transmitted is a communication network, such as the Internet. In this case, the encoded data are transmitted in accordance with an internet protocol (IP). The transmission path through which the encoded data are transmitted is not limited to that example, and may be implemented by a communication interface that complies with the Universal Serial Bus (USB) standard, the Institute Electrical and Electronics Engineers 1394 (IEEE 1394) standard, or the like or a wireless communication typified by the IEEE 802.11 standard or the like.

Subsequently to the input of the image data for the seven lines resulting from the first round of the processing, image data up to the bottom line on the screen are sequentially input to the image encoding unit 312. In response to input In-n of the image data (n is 2 or greater), the image encoding unit 312 performs wavelet transform WT-n, reordering Ord-n, and entropy encoding EC-n on four lines at a time. The reordering Ord and the entropy encoding EC that correspond to the last round of the processing at the image encoding unit 312 are performed on six lines. At the image encoding unit 312, the above-described processes are performed in a parallel manner, as depicted at A to D in FIG. 22.

Encoded data obtained by the entropy encoding EC-1 performed by the image encoding unit 312 are transmitted to the image decoding unit 331 through the transmission path and are then supplied to the entropy decoding unit 421. The entropy decoding unit 421 sequentially performs entropy-code decoding iEC-1 on the encoded data, obtained by the entropy encoding EC-1 and supplied to the entropy decoding unit 421, to reconstruct the coefficient data (as depicted at F in FIG. 22). The reconstructed coefficient data are sequentially stored in the coefficient buffer unit 422. When the coefficient data that are enough to enable inverse wavelet transform are stored in the coefficient buffer unit 422, the inverse wavelet transform unit 423 reads the coefficient data from the coefficient buffer unit 422 and uses the read coefficient data to perform inverse wavelet transform iWT-1 (as depicted at G in FIG. 22).

As described above with reference to FIG. 17, the inverse wavelet transform iWT-1 performed by the inverse wavelet transform unit 423 can be started at a point when the coefficients C4 and C5 are stored in the coefficient buffer unit 422. Thus, the delay from when the decoding iEC-1 is started by the entropy decoding unit 421 until the inverse wavelet transform iWT-1 is started by the inverse wavelet transform unit 423 corresponds to two lines.

At the inverse wavelet transform unit 423, when the inverse wavelet transform iWT-1 for the three lines resulting from the first round of the wavelet transform is completed, output Out-1 of image data generated by the inverse wavelet transform iWT-1 is performed (as depicted at H in FIG. 22). In the output Out-1, the image data of the first line is output, as described above with reference to FIGS. 17 and 18A to C.

Subsequently to the input of the encoded coefficient data for the three lines to the image decoding unit 331, the encoding being performed in the first round of the processing by the image encoding unit 312, coefficient data encoded by entropy encoding EC-n (n is 2 or greater) are sequentially input to the image decoding unit 331. With respect to the input coefficient data, the image decoding unit 331 performs entropy decoding iEC-n and inverse wavelet transform iWT-n on four lines at a time and sequentially performs output Out-n on the image data reconstructed by the inverse wavelet transform iWT-n, as described above. The entropy decoding iEC and the inverse wavelet transform iWT that correspond to the last round at the image encoding unit 312 are performed on six lines, and eight lines are output as the output Out. The image decoding unit 331 performs the above-described processes in a parallel manner, as illustrated at F to H in FIG. 22.

The image encoding unit 312 and the image decoding unit 331 sequentially perform the corresponding processes in a parallel manner in a direction from the screen top side to the screen bottom side, as described above, thereby making it possible to perform image encoding processing and image decoding processing with lower delay.

Now, calculation of a delay time from the input of an image until the output of the image when the wavelet transform is performed up to decomposition level 2 by using a 5×3 filter is discussed with reference to FIG. 22. The delay time from when image data for the first line is input to the image encoding unit until the image data for the first line is output from the image decoding unit 331 is given by the total of parameters described below. The delay time in this case does not involve a delay that varies depending on the system configuration, such as a delay in a transmission path and a delay due to actual processing timing of each unit in the apparatus.

(1) Delay D_WT from when image data for the first line are input until the wavelet transform WT-1 for seven lines is completed.

(2) Time D_Ord involved in the reordering Ord-1 of coefficients for three lines.

(3) Time D_EC involved in the entropy encoding EC-1 for the three lines.

(4) Time D_iEC involved in the entropy decoding iEC-1 for the three lines.

(5) Time D_iWT involved in the inverse wavelet transform iWT-1 for the three lines.

With reference to FIG. 22, an attempt is made to calculate a delay with the above-described parameters. The delay D_WT in (1) corresponds to the amount of time for ten lines. Each of the time D_Ord in (2), the time D_EC in (3), the time D_iEC in (4), and the time D_iWT in (5) corresponds to the amount of time for the three lines. At the image encoding unit 312, when one line is processed after start of the reordering Ord-1, the entropy encoding EC-1 can be started. Similarly, at the image decoding unit 331, when two lines are processed after start of the entropy decoding iEC-1, the inverse wavelet transform iWT-1 can be started. The processing of the entropy decoding iEC-1 can also be started when the encoding for one line is completed in the entropy encoding EC-1.

Thus, in the example in FIG. 22, the delay time from when the image data for the first line is input to the image encoding unit 312 until the image data for the first line is output from the image decoding unit 331 corresponds to 17 lines (=10+1+1+2+3).

The delay time will now be discussed in conjunction with a more specific example. When high-definition television (HDTV) interlace video signals are input as the image data, for example, one frame is realized with a resolution of 1920 pixels×1080 lines and one field is realized with a resolution of 1920 pixels×540 lines. Thus, when the frame frequency is assumed to be 30 Hz, 540 lines in one field are input to the image encoding unit 312 in the period of 16.67 ms (=1 s/60 fields).

As a result, the delay time taken for the input of the image data for seven lines is 0.216 ms (=16.67 ms×7/540 lines), which is a significantly shorter time than, for example, the update time of one field. In addition, since the number of lines to be processed is small, the delay time is also greatly reduced with respect to the total of the delay D_WT in (1), the time D_Ord in (2), the time D_EC in (3), the time D_iEC in (4), and the time D_iWT in (5) described above. When the elements that perform the above-described processes are implemented by hardware, the processing time can be further reduced.

The reordering of the coefficient data may also be performed subsequent to the entropy encoding. Such an implementation makes it possible to reduce the storage capacity used by the coefficient-reordering buffer unit 412.

The encoded data transmitted between the terminal apparatus 301 and the advertisement presenting apparatus 302 may be implemented with packets.

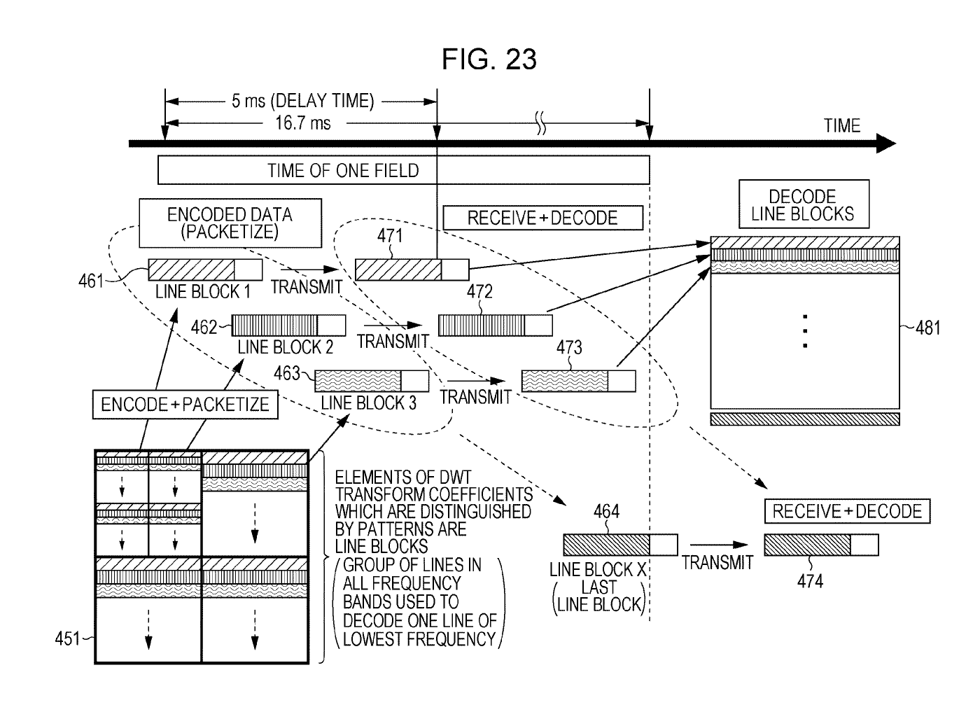

FIG. 23 schematically illustrates an example of transmission and reception of the encoded data. As described above, the image data, while it is being input by an amount corresponding to a predetermined number of lines, is wavelet-transformed for each line block (“sub-band 451”). Then, when the wavelet transform reaches a predetermined decomposition level, coefficient lines in the lowest-frequency sub-band to the highest-frequency sub-band are reordered in the order opposite to the order in which they are generated, i.e., are reordered in an order of low frequencies to high frequencies.

In the sub-band 451 in FIG. 23, portions distinguished by the patterns of oblique lines, vertical lines, and wavy lines represent line blocks that are different from one another (white portions in the sub-band 451 are similarly divided into line blocks for processing, as indicated by arrows). The coefficients of the reordered line blocks are entropy-encoded as described above, so that encoded data are generated.

In this case, for example, if the communication unit 313 sends out the encoded data unmodified, there are cases in which it is difficult for the image obtaining unit 111 to distinguish between the boundaries of the line blocks (or there are cases in which complicated processing is involved). Accordingly, for example, the communication unit 313 is adapted to append a header to the encoded data for each line block and to send out a packet containing the header and the encoded data.

That is, as illustrated in FIG. 23, the communication unit 313 packetizes the encoded data of the first line block (“line block 1”) and sends out the resulting packet to the image obtaining unit 111 as a transmitted packet 461. Upon receiving the packet (“received packet 471”), the image obtaining unit 111 extracts the encoded data and supplies it to the image decoding unit 331. The image decoding unit 331 decodes the supplied encoded data (the encoded data contained in the received packet 471).

The communication unit 313 also packetizes the encoded data of the second line block (“line block 2”) and sends the resulting packet to the image obtaining unit 111 as a transmitted packet 462. Upon receiving the packet (“received packet 472”), the image obtaining unit 111 extracts the encoded data and supplies it to the image decoding unit 331. The image decoding unit 331 decodes the supplied encoded data (i.e., the encoded data contained in the received packet 472).

In addition, when encoded data for the third line block (“line block 3”) is generated, the communication unit 313 packetizes the generated encoded data and sends out the resulting packet to the image obtaining unit 111 as a transmitted packet 463. Upon receiving the packet (“received packet 473”), the image obtaining unit 111 extracts the encoded data and supplies it to the image decoding unit 331. The image decoding unit 331 decodes the supplied encoded data (i.e., the encoded data contained in the received packet 473).

The communication unit 313 and the image obtaining unit 111 repeatedly perform processing as described above until the Xth final line block (“line block X”) is reached (“transmitted packet 464” and “received packet 474”). As a result of the above-described processing, the image decoding unit 331 generates a decoded image 481.

As described above, the advertisement presenting system 300 illustrated in FIG. 10 can realize low-delay encoding and decoding and can present more appropriate information to the user with low delay.

### [Flow of Advertisement Presenting Processing]

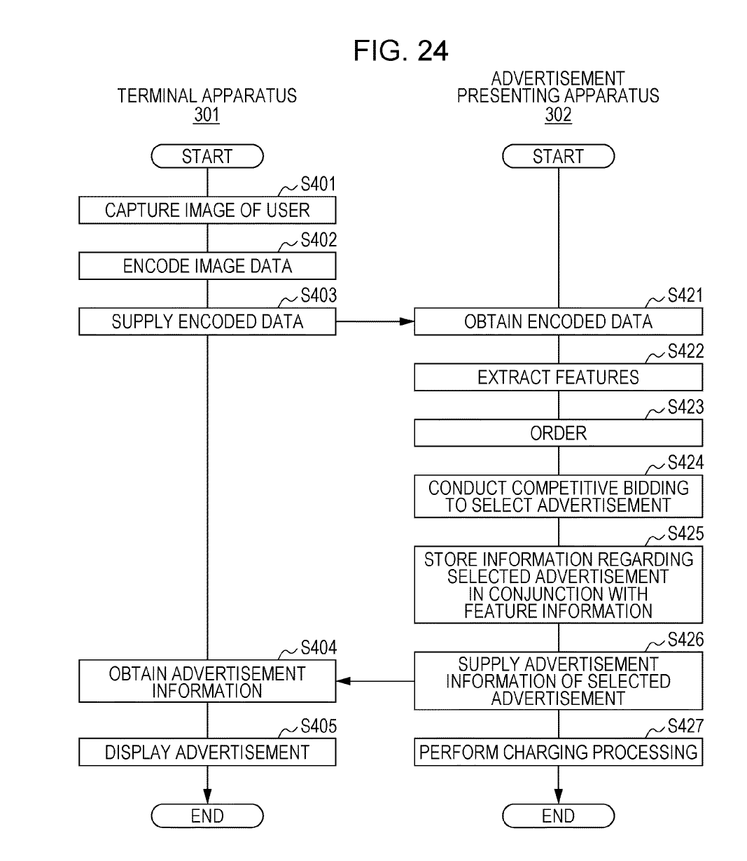

Next, an example of a flow of the advertisement presenting processing performed by the advertisement presenting system 300 illustrated in FIG. 10 will be described with reference to a flowchart illustrated in FIG. 24.

When the advertisement presenting processing is started, the image capture unit 311 in the terminal apparatus 301 captures an image of the user 10 to acquire image data in step S401.

In step S402, the image encoding unit 312 encodes the image data of the user 10, the image data being obtained in step S401, to obtain encoded data.

In step S403, the communication unit 313 supplies the encoded data, obtained in the process in step S402, to the advertisement presenting apparatus 302.

In step S421, the image obtaining unit 111 in the advertisement presenting apparatus 302 obtains the encoded data. The image decoding unit 331 decodes the obtained encoded data to obtain decoded image.

In step S422, the feature extracting unit 112 analyzes the decoded image obtained in the process in step S421 and extracts features of the user 10, who is the subject of the image, to obtain feature information thereof.

In step S423, the SSP unit 113 generates order information for ordering competitive bidding for an advertisement to be requested, by using the feature information of the user 10, the feature information being obtained in the process in step S422, and information regarding the specifications of the advertisement to be requested, the information being obtained from the control unit 101. The SSP unit 113 uses the generated order information to order the competitive bidding.

In step S424, the RTB unit 121 in the DSP unit 114 conducts the competitive bidding to select a most appropriate advertisement for the user 10. The advertisement distribution unit 123 supplies advertisement information of the selected advertisement and corresponding bidding information to the SSP unit 113 as a competitive-bidding result.

In step S425, the database 122 stores the information regarding the selected advertisement in conjunction with the corresponding feature information.

In step S426, the advertisement output unit 115 supplies the selected advertisement information of the selected advertisement to the terminal apparatus 301.

In step S404, the communication unit 313 in the terminal apparatus 301 obtains the advertisement information.

In step S405, the display unit 314 displays, on a monitor, the advertisement corresponding to the advertisement information obtained in step S404.

In step S427, the charging processing unit 116 performs charging processing on the basis of information supplied from the SSP unit 113.

When the process in step S427 is completed, the advertisement presenting processing ends.

By executing the advertisement presenting processing in the manner described above, the advertisement presenting system 300 can select an advertisement on the basis of the features of an image of a user. It is therefore possible to present more-appropriate information to a new user for whom no past history information is available.

Although a case in which the image features are analyzed by the advertisement presenting apparatus has been described above, the present technology is not limited thereto and the image features may also be analyzed by an apparatus other than the advertisement presenting apparatus. For example, the image features may also be analyzed by a terminal apparatus that acquires an image of the user 10 through image capture. The image-feature analysis may also be performed by an apparatus other than the terminal apparatus and the advertisement presenting apparatus.

The present technology is directed to a real-time advertising system using the Internet or the like, an apparatus, a method, and a program. The present technology is also applicable to digital signage using a display apparatus, an advertising system aimed at the general public, and so on. As a usage scenario or a use case, the present technology may be applied to an advertisement that targets individuals and that utilizes web cameras attached to personal computers or cameras included in smartphones. Another possible application is to capture images of pedestrians at a station or a place where people gather by using a camera attached to a large-screen display (digital signage) placed for advertising and to display an advertisement targeting the pedestrians. It is also effective to acquire images of customers in an elevator, a pathway, or the like in a department store or a shop and to display an advertisement in which the customers have interests.

### 4. Fourth Embodiment

### [Computer]

The above described series of processes can be executed by hardware or can be executed by software. When the series of processes is executed by software, a program included in the software is installed on a computer. Examples of the computer include a computer incorporated into dedicated hardware or a general-purpose personal computer that can execute various functions through installation of various programs.

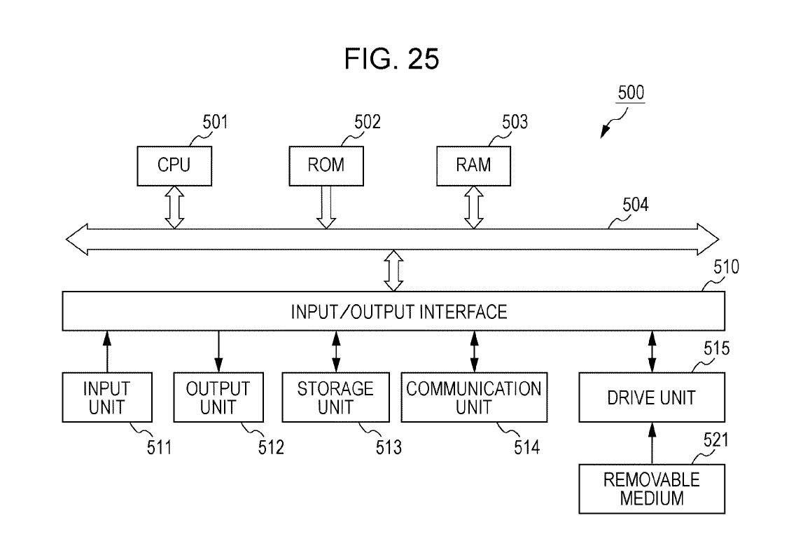

FIG. 25 is a block diagram illustrating an example of the hardware configuration of a computer that executes the above-described series of processes by using a program.

In a computer 500 illustrated in FIG. 25, a central processing unit (CPU) 501, a read only memory (ROM) 502, and a random access memory (RAM) 503 are coupled to each other through a bus 504.

An input/output interface 510 is also coupled to the bus 504. An input unit 511, an output unit 512, a storage unit 513, a communication unit 514, and a drive 515 are also coupled to the input/output interface 510.

The input unit 511 includes, for example, a keyboard, a mouse, a microphone, a touch panel, and an input terminal. The output unit 512 includes, for example, a display, a speaker, and an output terminal. The storage unit 513 includes, for example, a hard disk, a RAM disk, and a nonvolatile memory. The communication unit 514 includes, for example, a network interface. The drive 515 drives a removable medium 521, such as a magnetic disk, an optical disk, a magneto-optical disk, or a semiconductor memory.

In the computer 500 configured as described above, the CPU 501 loads, for example, a program stored in the storage unit 513 into the RAM 503 via the input/output interface 510 and the bus 504 and executes the program to thereby perform the above-described series of processes. For example, data that the CPU 501 uses to execute various types of processing are also stored in the RAM 503, as appropriate.

The program to be executed by the computer 500 (particularly, the CPU 501) can be recorded to the removable medium 521, such as packaged media, for execution. The program can also be supplied through a wired or wireless transmission medium, such as a local area network, the Internet, or digital satellite broadcast.

In the computer 500, the program can be installed in the storage unit 513 via the input/output interface 510 through loading of the removable media 521 into the drive 515. The program can also be received by the communication unit 514 through the wired or wireless transmission medium and be installed in the storage unit 513. In addition, the program can also be pre-installed in the ROM 502 or the storage unit 513.

The program executed by the computer may be a program that time-sequentially performs processes according to the order described herein, may be a program that performs processes in parallel, or may be a program that performs processes at an arbitrary timing, for example, at the time of call of the program.

Herein, the steps describing the program recorded to the storage medium not only include processes that are time-sequentially performed according to the described order, but also include processes that are concurrently or individually executed without being time-sequentially processed.

The term “system” as used herein refers to a collection of multiple elements (e.g., apparatuses, devices, and modules (components)) and may or may not include all of the elements in the same housing. Accordingly, the system also encompasses multiple apparatuses accommodated in separate housings and connected through a network, as well as a single apparatus including multiple modules accommodated in one housing.

The element described above as a single apparatus (or a single processing unit) may also be divided to configure multiple apparatuses (or processing units). Conversely, the elements described above as multiple apparatuses (or processing units) may also be integrated together to configure a single apparatus (or a single processing unit). Needless to say, an element other than those described above may also be added to the configuration of the above-described individual apparatuses (or processing units). Moreover, as long as the configuration and the operation of the entire system are substantially the same, part of the configuration of one apparatus (or processing unit) may also be incorporated into the configuration of another apparatus (or processing unit).

While preferred embodiments of the present disclosure have been described above in detail with reference to the accompanying drawings, the technical scope of the present disclosure is not limited thereto. It is apparent to a person having ordinary skill in the art that various changes and modifications can be made within the spirit and scope of the appended claims, and it is to be understood that such changes and modifications are also naturally encompassed by the technical scope of the present disclosure.

For example, the present technology may employ a form of cloud computing in which one function is processed through sharing and cooperation by multiple apparatuses over a network.

Each of the steps described above and illustrated in the flowcharts may be executed by a single apparatus or may be executed through sharing by multiple apparatuses.

In addition, when one step includes multiple processes, the multiple processes included in the step may be executed by a single apparatus or may be executed through sharing by multiple apparatuses.

The present technology may employ the following configuration:

(1) An information processing apparatus including:

an extracting unit configured to extract predetermined feature information from an image;

an order-information generating unit configured to generate order information for ordering competitive bidding for selecting output information, by using the feature information extracted by the extracting unit;

a competitive-bidding unit configured to conduct the competitive bidding to select output information on the basis of the order information generated by the order-information generating unit; and

an output unit configured to output the output information selected in the competitive bidding conducted by the competitive-bidding unit.

(2) The information processing apparatus according to (1), wherein the feature information includes at least one of gender, age, body height, skin color, hairstyle, and clothing of a person included in the image.

(3) The information processing apparatus according to (1) or (2), wherein the order-information generating unit includes the feature information and the order information including information regarding output information to be requested.

(4) The information processing apparatus according to one of (1) to (3), wherein the competitive-bidding unit selects, from among pieces of output information submitted for the competitive bidding, output information having a bidding condition optimum for the order information.

(5) The information processing apparatus according to (4), wherein the output information selected by the competitive-bidding unit has a bidding condition that matches a condition for requested output information and that is most appropriate for the feature information.

(6) The information processing apparatus according to one of (1) to (5), further including:

an obtaining unit configured to obtain the image transmitted from another apparatus,

wherein the extracting unit extracts predetermined feature information from the image obtained by the obtaining unit.

(7) The information processing apparatus according to one of (1) to (6), further including

an image capture unit configured to capture an image of a subject,

wherein the extracting unit extracts predetermined feature information from the subject image captured by the image capture unit.

(8) The information processing apparatus according to one of (1) to (7), wherein the output unit displays the output information as an image.

(9) The information processing apparatus according to one of (1) to (8), wherein the output unit supplies the output information to another apparatus.

(10) The information processing apparatus according to one of (1) to (9), further including:

a competitive-bidding result storage unit configured to store a result of the competitive bidding in conjunction with the feature information for the order information, the competitive bidding being conducted by the competitive-bidding unit.

(11) The information processing apparatus according to one of (1) to (10), further including:

an encoding unit configured to encode the image to obtain encoded data; and

an encoded-data storage unit configured to store therein the encoded data obtained by the encoding unit.

(12) The information processing apparatus according to (11), wherein

the encoding unit encodes the image for each line block having a number of lines used for generating a lowest-frequency component for at least one line in a wavelet transform.

(13) The information processing apparatus according to (11) or (12), further including

a decoding unit configured to decode the encoded data generated by the encoding unit.

(14) The information processing apparatus according to (1) to (13), further including:

an obtaining unit configured to obtain encoded data supplied from another apparatus, the encoded data being data of the image subjected to encoding; and

a decoding unit configured to decode the encoded data to obtain the image, the encoded data being obtained by the obtaining unit.

wherein the extracting unit extracts predetermined feature information from the image obtained by the decoding unit.

(15) The information processing apparatus according to (14), wherein the encoded data is data obtained by encoding the image for each line block having a number of lines used for generating a lowest-frequency component for at least one line in a wavelet transform, and

the decoding unit decodes the encoded data for each line block.

(16) The information processing apparatus according to (15), wherein

the encoded data is data of the image subjected to the wavelet transform and entropy encoding, and

the decoding unit includes
an entropy decoding unit configured to perform entropy decoding on the encoded data to obtain wavelet-transformed coefficients, and
an inverse wavelet transform unit configured to perform an inverse wavelet transform on the wavelet-transformed coefficients obtained by the entropy decoding unit.

(17) The information processing apparatus according to (16), wherein the encoded data is data of the image subjected to the wavelet transform, quantization, and entropy encoding;
the decoding unit further includes a dequantizing unit configured to dequantize quantized wavelet-transformed coefficients to obtain wavelet-transformed coefficients, the quantized wavelet-transformed coefficients being obtained by the entropy decoding unit performing entropy decoding on the encoded data; and
the inverse wavelet transform unit performs an inverse wavelet transform on the wavelet-transformed coefficients obtained by the dequantizing unit.

(18) An information processing method for an information processing apparatus, the method including:

extracting, by the information processing apparatus, predetermined feature information from an image;

generating, by the information processing apparatus, order information for ordering competitive bidding for selecting output information, by using the extracted feature information;

conducting, by the information processing apparatus, the competitive bidding to select output information on the basis of the generated order information; and

outputting, by the information processing apparatus, the output information selected in the conducted competitive bidding.

(19) A program for causing a computer to function as:

an extracting unit that extracts predetermined feature information from an image;

an order-information generating unit that generates order information for ordering competitive bidding for selecting output information, by using the feature information extracted by the extracting unit;

a competitive-bidding unit that conducts the competitive bidding to select output information on the basis of the order information generated by the order-information generating unit; and

an output unit that outputs the output information selected in the competitive bidding conducted by the competitive-bidding unit.

(20) An information processing system including:

a terminal apparatus; and

an information presenting apparatus,

wherein the terminal apparatus includes
an image capture unit configured to capture an image of a subject,
an encoding unit configured to encode the subject image for each line block having a number of lines used for generating a lowest-frequency component for at least one line in a wavelet transform, to obtain encoded data, the subject image being captured by the image capture unit,
a first supplying unit configured to supply the encoded data to the information presenting apparatus, the encoded data being obtained by the encoding unit,
a first obtaining unit configured to obtain information from the information presenting apparatus, and
an output unit configured to perform output on the basis of the information obtained by the first obtaining unit; and

the information presenting apparatus includes
a second obtaining unit configured to obtain the encoded data supplied by the first supplying unit in the terminal apparatus,
a decoding unit configured to decode the encoded data for each line block to obtain the subject image, the encoded data being obtained by the second obtaining unit,
an extracting unit configured to extract predetermined feature information from the subject image obtained by the decoding unit,
an order-information generating unit configured to generate order information for ordering competitive bidding for selecting output information, by using the feature information extracted by the extracting unit,
a competitive-bidding unit configured to conduct the competitive bidding to select the output information on the basis of the order information generated by the order-information generating unit, and
a second supplying unit configured to supply information regarding the output information to the terminal apparatus, the output information being selected in the competitive bidding conducted by the competitive-bidding unit, and

wherein the first obtaining unit in the terminal apparatus obtains the information supplied by the second supplying unit, and the output unit in the terminal apparatus outputs the output information on the basis of the obtained information.

The present disclosure contains subject matter related to that disclosed in Japanese Priority Patent Application JP 2012-197116 filed in the Japan Patent Office on Sep. 7, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
an extracting unit configured to extract predetermined feature information from an image;
an order-information generating unit configured to generate order information for ordering competitive bidding for selecting output information, by using the feature information extracted by the extracting unit;
a competitive-bidding unit configured to conduct the competitive bidding to select output information on the basis of the order information generated by the order-information generating unit; and
an output unit configured to output the output information selected in the competitive bidding conducted by the competitive-bidding unit.

2. The information processing apparatus according to claim 1, wherein the feature information includes at least one of gender, age, body height, skin color, hairstyle, and clothing of a person included in the image.

3. The information processing apparatus according to claim 1, wherein the order-information generating unit includes the feature information and the order information including information regarding output information to be requested.

4. The information processing apparatus according to claim 1, wherein the competitive-bidding unit selects, from among pieces of output information submitted for the competitive bidding, output information having a bidding condition optimum for the order information.

5. The information processing apparatus according to claim 4, wherein the output information selected by the competitive-bidding unit has a bidding condition that matches a condition for requested output information and that is most appropriate for the feature information.

6. The information processing apparatus according to claim 1, further comprising:
an obtaining unit configured to obtain the image transmitted from another apparatus,
wherein the extracting unit extracts predetermined feature information from the image obtained by the obtaining unit.

7. The information processing apparatus according to claim 1, further comprising
an image capture unit configured to capture an image of a subject,
wherein the extracting unit extracts predetermined feature information from the subject image captured by the image capture unit.

8. The information processing apparatus according to claim 1, wherein the output unit displays the output information as an image.

9. The information processing apparatus according to claim 1, wherein the output unit supplies the output information to another apparatus.

10. The information processing apparatus according to claim 1, further comprising:
a competitive-bidding result storage unit configured to store a result of the competitive bidding in conjunction with the feature information for the order information, the competitive bidding being conducted by the competitive-bidding unit.

11. The information processing apparatus according to claim 1, further comprising:
an encoding unit configured to encode the image to obtain encoded data; and
an encoded-data storage unit configured to store therein the encoded data obtained by the encoding unit.

12. The information processing apparatus according to claim 11, wherein
the encoding unit encodes the image for each line block having a number of lines used for generating a lowest-frequency component for at least one line in a wavelet transform.

13. The information processing apparatus according to claim 11, further comprising a decoding unit configured to decode the encoded data generated by the encoding unit.

14. The information processing apparatus according to claim 1, further comprising:
an obtaining unit configured to obtain encoded data supplied from another apparatus, the encoded data being data of the image subjected to encoding; and
a decoding unit configured to decode the encoded data to obtain the image, the encoded data being obtained by the obtaining unit,
wherein the extracting unit extracts predetermined feature information from the image obtained by the decoding unit.

15. The information processing apparatus according to claim 14, wherein the encoded data is data obtained by encoding the image for each line block having a number of lines used for generating a lowest-frequency component for at least one line in a wavelet transform, and
the decoding unit decodes the encoded data for each line block.

16. The information processing apparatus according to claim 15, wherein the encoded data is data of the image subjected to the wavelet transform and entropy encoding; and
the decoding unit includes
an entropy decoding unit configured to perform entropy decoding on the encoded data to obtain wavelet-transformed coefficients, and
an inverse wavelet transform unit configured to perform an inverse wavelet transform on the wavelet-transformed coefficients obtained by the entropy decoding unit.

17. The information processing apparatus according to claim 16, wherein
the encoded data is data of the image subjected to the wavelet transform, quantization, and entropy encoding;
the decoding unit further includes a dequantizing unit configured to dequantize quantized wavelet-transformed coefficients to obtain wavelet-transformed coefficients, the quantized wavelet-transformed coefficients being obtained by the entropy decoding unit performing entropy decoding on the encoded data; and
the inverse wavelet transform unit performs an inverse wavelet transform on the wavelet-transformed coefficients obtained by the dequantizing unit.

18. An information processing method for an information processing apparatus, the method comprising:
extracting, by the information processing apparatus, predetermined feature information from an image;
generating, by the information processing apparatus, order information for ordering competitive bidding for selecting output information, by using the extracted feature information;
conducting, by the information processing apparatus, the competitive bidding to select output information on the basis of the generated order information; and
outputting, by the information processing apparatus, the output information selected in the conducted competitive bidding.

19. A program for causing a computer to function as:
an extracting unit that extracts predetermined feature information from an image;
an order-information generating unit that generates order information for ordering competitive bidding for selecting output information, by using the feature information extracted by the extracting unit;
a competitive-bidding unit that conducts the competitive bidding to select output information on the basis of the order information generated by the order-information generating unit; and
an output unit that outputs the output information selected in the competitive bidding conducted by the competitive-bidding unit.

20. An information processing system comprising:
a terminal apparatus; and
an information presenting apparatus,
wherein the terminal apparatus includes
an image capture unit configured to capture an image of a subject,
an encoding unit configured to encode the subject image for each line block having a number of lines used for generating a lowest-frequency component for at least one line in a wavelet transform, to obtain encoded data, the subject image being captured by the image capture unit,
a first supplying unit configured to supply the encoded data to the information presenting apparatus, the encoded data being obtained by the encoding unit,
a first obtaining unit configured to obtain information from the information presenting apparatus, and
an output unit configured to perform output on the basis of the information obtained by the first obtaining unit; and
the information presenting apparatus includes
a second obtaining unit configured to obtain the encoded data supplied by the first supplying unit in the terminal apparatus,
a decoding unit configured to decode the encoded data for each line block to obtain the subject image, the encoded data being obtained by the second obtaining unit,
an extracting unit configured to extract predetermined feature information from the subject image obtained by the decoding unit,
an order-information generating unit configured to generate order information for ordering competitive bidding for selecting output information, by using the feature information extracted by the extracting unit,
a competitive-bidding unit configured to conduct the competitive bidding to select the output information on the basis of the order information generated by the order-information generating unit, and
a second supplying unit configured to supply information regarding the output information to the terminal apparatus, the output information being selected in the competitive bidding conducted by the competitive-bidding unit; and
wherein the first obtaining unit in the terminal apparatus obtains the information supplied by the second supplying unit, and the output unit in the terminal apparatus outputs the output information on the basis of the obtained information.
